(19) United States
(12) Patent Application Publication
(10) Pub. No.: US 2026/0169890 A1
(43) Pub. Date: Jun. 18, 2026

(54) SYSTEMS AND METHODS FOR REAL-TIME PROGRAM-SPECIFIC LOG CONSOLIDATION FOR INTRUSION DETECTION

(71) Applicant: UNIVERSITY OF SOUTH FLORIDA, Tampa, FL (US)

(72) Inventors: Yao LIU, Tampa, FL (US); Xiao HAN, Tampa, FL (US); Zhuo LU, Tampa, FL (US)

(21) Appl. No.: 19/425,443

(22) Filed: Dec. 18, 2025

Related U.S. Application Data
(60) Provisional application No. 63/735,607, filed on Dec. 18, 2024.

(51) Int. Cl. G06F 11/34; G06F 21/55

(52) U.S. Cl. CPC G06F 11/3476; G06F 21/554

(57) ABSTRACT

Systems and methods for real-time program-specific log consolidation for intrusion detection are provided. A method for real-time program-specific log consolidation for intrusion detection in a computing system, including, in real-time during operation of the computing system: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

### CROSS-REFERENCE TO RELATED APPLICATION(S)

This application claims the benefit of and priority to U.S. Provisional Application No. 63/735,607, filed on Dec. 18, 2024, the entirety of which is hereby incorporated by reference for all purposes.

### TECHNICAL FIELD

This disclosure generally relates to systems and methods for real-time program-specific log consolidation for intrusion detection.

### BACKGROUND

Enterprises today are increasingly threatened by Advanced Persistent Threats (APTs), carried out by skilled adversaries and often remaining undetected for months. A promising approach to detect such intrusions is to parse system logs into provenance graphs that capture dependencies between intrusion (or attack) activities. However, a major challenge with this approach is that logs can rapidly grow to enormous sizes, imposing severe memory overhead during forensic analysis. While existing research has introduced forensic-informed methods to reduce log size, these techniques often achieve modest reductions and may rely on offline processing at a central server, limiting their scalability for real-time analysis.

Accordingly, there is a need for systems and methods for real-time program-specific log consolidation for intrusion detection.

### SUMMARY

This disclosure pertains to systems and methods for real-time program-specific log consolidation for intrusion detection.

A first aspect of this disclosure pertains to a method for real-time program-specific log consolidation for intrusion detection in a computing system, including, in real-time during operation of the computing system: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

A second aspect of this disclosure pertains to the method of the first aspect, wherein repeated operations are aggregated into the unique access links based on respective execution sequences of the operations.

A third aspect of this disclosure pertains to the method of the first aspect, and further includes consolidating duplicate logs from respective ones among the plurality of subjects that originate from a same execution sequence.

A fourth aspect of this disclosure pertains to the method of the first aspect, and further includes identifying a malicious object among the plurality of objects based on a malicious object triggering an alert.

A fifth aspect of this disclosure pertains to the method of the fourth aspect, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

A sixth aspect of this disclosure pertains to the method of the fourth aspect, and further includes determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

A seventh aspect of this disclosure pertains to one or more non-transitory computer-readable media storing instructions that, when executed by at least one processor of a computing system, cause the computing system to execute instructions for real-time program-specific log consolidation for intrusion detection in the computing system in real-time during operation of the computing system, the instructions including: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

An eighth aspect of this disclosure pertains to the one or more non-transitory computer-readable media of the seventh aspect, wherein repeated operations are aggregated into the unique access links based on respective execution sequences of the operations.

A ninth aspect of this disclosure pertains to the one or more non-transitory computer-readable media of the seventh aspect, wherein the instructions further include consolidating duplicate logs from respective ones among the plurality of subjects that originate from a same execution sequence.

A tenth aspect of this disclosure pertains to the one or more non-transitory computer-readable media of the seventh aspect, wherein the instructions further include identifying a malicious object among the plurality of objects based on a malicious object triggering an alert.

An eleventh aspect of this disclosure pertains to the one or more non-transitory computer-readable media of the tenth aspect, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

A twelfth aspect of this disclosure pertains to the one or more non-transitory computer-readable media of the tenth aspect, wherein the instructions further include determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

A thirteenth aspect of this disclosure pertains to a system for real-time program-specific log consolidation for intrusion detection, including: one or more processors, and at least one memory including at least one non-transitory computer-readable medium storing instructions for real-time program-specific log consolidation for intrusion detection in a computing system that, when executed by at least one of the one or more processors, cause the system to perform actions corresponding to the instructions in real-time during operation of the computing system, the instructions including: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

A fourteenth aspect of this disclosure pertains to the system of the thirteenth aspect, wherein repeated operations are aggregated into the unique access links based on respective execution sequences of the operations.

A fifteenth aspect of this disclosure pertains to the system of the thirteenth aspect, wherein the instructions further include consolidating duplicate logs from respective ones among the plurality of subjects that originate from a same execution sequence.

A sixteenth aspect of this disclosure pertains to the system of the thirteenth aspect, wherein the instructions further include identifying a malicious object among the plurality of objects based on a malicious object triggering an alert.

A seventeenth aspect of this disclosure pertains to the system of the sixteenth aspect, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

An eighteenth aspect of this disclosure pertains to the system of the sixteenth aspect, wherein the instructions further include determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a schematic diagram of an example execution sequence.

FIG. 2A is a schematic diagram of an example provenance graph.

FIG. 2B is a schematic diagram of an example profile hierarchy.

FIG. 3A is a schematic diagram of an example provenance graph.

FIG. 3B is a schematic diagram of an example access network.

FIG. 4 is a schematic diagram of an example data model.

FIG. 5 is a graph of a cumulative distribution function (CDF).

FIG. 6 is a graph of experimental results.

FIGS. 7-10 are schematic diagrams of experimental results for access networks.

FIG. 11 is a schematic diagram of an experimental result for an access network.

FIG. 12 is a flowchart for an example method.

FIG. 13 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, specific embodiments are shown in the drawings and will be described in detail herein with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

Modern enterprises often fall victim to long-term and multi-stage attacks, commonly known as Advanced Persistent Threats (APTs), such as the well-known data breaches at some major corporations. These intrusions (or attacks) are characterized by their ability to remain undetected for extended periods while systematically infiltrating enterprise networks, conducting reconnaissance, and exfiltrating sensitive information. For example, one breach leaked confidential information of 21.5 million individuals for over 8 months.

Intrusion detection systems (IDS) are considered the first line of defense against APT attacks through the identification of individual events, which may align with the MITRE ATT&CK® framework of adversarial tactics, techniques, and procedures (TTPs). However, the absence of contextual connectivity between alerts makes it challenging for analysts to effectively investigate malicious activities.

### Provenance-Based Intrusion Detection

To aid alert investigation, data provenance has emerged as a promising approach for intrusion/attack detection and forensics. The core idea involves parsing system-level logs into a data structure known as a data provenance graph, where logs are collected from standard auditing frameworks, such as LINUX® Audit and Event Tracing for WINDOWS® (ETW).

For forensic analysis, the provenance graph preserves dependencies between system entities, including subjects (e.g., processes) and objects (e.g., files and network sockets). It simplifies attack investigation by enabling graph traversal operations, such as backward and forward searches. Given a symptom event, a backward search traces the potential entry point (e.g., an untrusted internet protocol (IP) address) of this attack, while a forward search identifies the ramifications. Both analyses together provide a holistic view of the attack scenario by connecting the individual attack steps.

### Severe Server-Side Memory Overhead

Nonetheless, the state-of-the-art Provenance-based Intrusion Detection Systems (PIDSes) face a significant challenge related to server-side memory consumption, as logs can quickly grow to unwieldy sizes and lead to substantial memory overhead.

Depending on machine loads, log generation rates have been reported to range from 1 GB to 33 GB per host per day. Even for a relatively small enterprise with hundreds of hosts, this can lead to terabytes of logs per day. The storage costs can quickly become prohibitive, deterring enterprises from investing in long-term log retention. In practice, logs are often stored in a small ring buffer, which provides only a few days of storage. Such limited capacity is particularly problematic given the extended “dwell times” associated with high-profile data breaches. Even worse, data provenance that relies on graph searches can become computationally expensive when dealing with such large datasets.

### Existing Data Reduction and Limitations

Considering these challenges, a rich literature has focused on developing log reduction techniques. Some efforts involved reducing log size through the application of graph-specific compression schemes. However, these schemes inevitably add additional decompression latency and fail to remove redundant logs.

It has been observed that the majority of log data describing system activities is very unlikely to contribute to forensics. To mitigate this, semantic pruning has been developed to filter out redundant events. Log Garbage Collection (“LogGC”) removes “dead” events describing temporary file I/O, as those do not alter the forensic values. Causality-Preserving Reduction (CPR) (or Causality-Preserving Replay) removes input/output (I/O) events that are not interleaved in a manner that impacts information flow. Similarly, Data Provenance Reduction (DPR) suggests that a compact provenance graph is sufficient as long as it produces the same tracing results as the full provenance graph.

A major challenge faced by existing reduction methods is their reliance on specific knowledge of application activities to filter out events with little forensic significance, which leads to limited reduction rates and/or incurs additional analysis costs. For example, the most aggressive method of Semantic Data Provenance Reduction (S-DPR) reduces log size by 87%, for example, 100 terabytes of logs can be reduced to 13 terabytes. However, it is typically achieved by traversing the entire graph in an offline mode, a process that may take several days to complete.

In recognition of these challenges, the inventors developed their reduction approach, an example of which is referred to herein as “Nano,” which reduced log size by 27 to 219 times at runtime in experiments and simulations. This means that 100 terabytes of log data can be reduced to approximately 3.7 to 0.45 terabytes with zero offline analysis cost. As such, analysts may be able to store months or even years worth of forensic data in the same space that would typically be consumed by PIDSes in just a few days.

Particularly, existing PIDSes experience severe server-side memory overhead due to their faithful reliance on dependencies of individual subjects, despite a significant portion of log data being redundant. In contrast, a core data structure in example embodiments of the present disclosure, termed the “access network,” focuses on consolidating dependencies of subjects into access links for each program when its execution is invoked by following a specific execution sequence of programs.

One intuition used by the inventors is that LINUX® systems frequently fork subjects to execute the same programs over time, resulting in massive volumes of duplicate logs. For instance, in a LINUX®-based Defense Advanced Research Projects Agency (DARPA) dataset, a system script “update-motd-updates-available” invoked command-line utilities “apt-config” and “dpkg” 21,600 times and generated 697,000 redundant events. Similarly, the inventors' evaluation of other datasets revealed substantial volumes of logs generated from the recurring execution of commands, such as “Isof” and “vmstat.”

The above high volume of process creation in LINUX® systems essentially reflects LINUX®'s design philosophy of “do one thing well” [54], where each program is designed to perform a specific task efficiently. Rather than running monolithic applications, complex operations are typically accomplished by composing multiple small, specialized programs, such as commands “vmstat” and “Isof” for system maintenance. This philosophy is implemented through a process-centric approach, which uses the fork/execute (“fork/exec”) mechanism to efficiently create child processes with memory isolation for executing specific programs. As a result, LINUX® systems inherently lead to process proliferation and generate duplicate logs due to repeated execution of the same specialized programs.

However, simply consolidating activities generated by subjects running the same programs may inadvertently eliminate critical forensic information, such as the origins of subjects involved in attacks. Presume that activities from all subjects running “dpkg” are merged. If an attacker leverages malware to execute “dpkg” and remove essential packages on a victim host, security analysts may face significant challenges in distinguishing the malicious behaviors initiated by the malware from the benign behaviors associated with the system script “update-motd-updates-available.”

To address this, the inventors introduced a hierarchical structure, termed the “profile hierarchy,” which abstracts subject origins through the execution sequences of programs. Each element in this hierarchy, termed a “profile node ρ,” is associated with a specific program. Each profile then denotes an execution sequence that captures the sequential order of program executions, including all programs associated with profiles tracing from the root profile to the profile itself.

For example, a profile ρ₁ associated with “dpkg” may represent the execution of “dpkg” when invoked by “apt-config,” which initially is executed by “update-motd-updates-available.” Conversely, another profile ρ₂ associated with “dpkg” can be defined to indicate its execution when triggered by malware. Because executions of the same program that originate from the same execution sequence are likely to exhibit similar behaviors and generate duplicate logs, example embodiments consolidate logs from subjects running “dpkg” into access links for ρ₁ and ρ₂ based on their respective origins, while preserving forensic information generated by these subjects.

Unlike existing PIDSes (e.g., NoDoze, HOLMES, and RapSheet) that detect APT attacks by traversing the traditional provenance graphs, example embodiments of the present disclosure enables attack detection by analyzing the connectivity between access links within the access network. The analysis can be performed by using existing rule-based detection strategies. To reduce false alarms during analysis, example embodiments also rebuild data dependencies between access links.

In summary, example embodiments may make at least the following contributions:
A profile hierarchy is provided, which is a hierarchical structure that abstracts and outlines subject origins using execution relationships between programs.
Based on the profile hierarchy, example embodiments provide an access network, which is a novel data structure that reduces log size by consolidating activities performed by subjects.
Example embodiments integrate state-of-the-art rule-based detection techniques. Through experimental evaluation across various LINUX®-based datasets from DARPA and lab environments, the inventors showed that example embodiments achieve detection accuracy comparable to existing PIDSes, while reducing log size by up to 219 times at runtime.

The inventors also discuss the difference between LINUX® and WINDOWS® systems, the adaptation of example embodiments for WINDOWS®, and integration of example embodiments with anomaly-based detection techniques.

As such, example embodiments of the present disclosure may provide a real-time log reduction approach for LINUX®-based systems that consolidates subject dependencies into program-specific data provenance. Example embodiments introduce at least two novel data structures, a “profile hierarchy” and an “access network.” Rather than preserving parent-child relationships between subjects, the profile hierarchy abstracts subject origins using the execution relationships between programs. Given subjects created by following the same execution order of programs, the access network consolidates their consistent activities into dependencies between programs being executed and the vertices being accessed, while retaining the connectivity between attack activities. Experimental evaluation, using LINUX®-based log data from government-agency sponsored red team exercises and the inventors' lab environments, demonstrates that example embodiments can effectively detect APT attacks comparable to existing provenance-based intrusion detection systems, while reducing log size by up to 219 times at runtime.

### Motivating Attack Scenario

The inventors conducted experiments using a dataset released by DARPA Transparent Computing Program during Engagement 3, which simulated a series of large-scale APT campaigns targeting an “Nginx” web server. Nginx (pronounced “engine-x”) is a high-performance, open-source web server and reverse proxy. Nginx is widely used for serving websites, load balancing, and handling high concurrency efficiently. The DARPA Transparent Computing Program during Engagement 3 dataset collects both malicious and benign activities in system logs from a Cadets host running the FREEBSD® system, and is referred to herein as “E3-Cadets.”

### Limitations of Data Provenance

Provenance graphs are typically designed to reside in memory for real-time querying. However, commodity auditing frameworks are known to generate sheer volumes of logs, often exceeding gigabytes per day on a single host. In the case of E3-Cadets, 14 GB of system logs, including 19 million events, were collected from a host over a 10-day simulation. The resulting provenance graph consumed 5 GB of memory space, including over 220,000 subjects. It may be envisioned that an enterprise comprises thousands of similar hosts. The vast volumes of logs collected from hosts can incur challenges such as those listed below:
Needle-in-a-haystack: This emerges as cyber analysts sift through enormous logs to identify real evidence of attacks, in which only a tiny fraction (e.g., less than 0, 1%) are activities related to attacks.
Storage Inefficiency: Maintaining logs is cost-intensive over a long term. In practice, the enterprise may purge the oldest data and retain the most recent (e.g., logs spanning a week) in accordance with its security budget constraints. However, this may destroy key evidence of malicious activities, as APT attacks often span weeks or even months.
Performance Overhead: Provenance-based detection systems rely on graph traversal operations to detect attack activities. However, performing these operations on such large graphs is prohibitively expensive.

### Generating Extraneous Logs

With a further study of system traces in E3-Cadets, the inventors noticed that many benign programs were repeatedly executed, generating a substantial volume of redundant events. Particularly, 150,000 out of 220,000 subjects were dedicated to the execution of six command-line utilities (e.g., “vmstat,” “head,” “top,” “sleep,” “date,” and “Isof”), which generated over 1.6 million redundant events. Similar log patterns were observed in both open-source datasets and the inventors' LINUX®-based lab environments. For example, in logs collected from a DARPA UBUNTU®-based THEIA® host (“E3-Theia”), 270,000 subjects were spawned to execute 173 different programs, with 52,300 subjects created to execute “stat” and “sed” commands. Likewise, in the inventors' lab environments, 70,000 subjects were spawned to execute 339 programs, including 22,400 subjects created to execute “rm,” “cat,” and “sed” commands.

Existing research has attempted to reduce such redundant logs without undermining the real intrusion/attack evidence. Nevertheless, excessive server-side memory overhead remains a bottleneck that hinders the proliferation of PIDSes. As used hereinafter, “PIDSes” refers to provenance-based detection techniques. For comparison, WINDOWS® process management is discussed below, which primarily uses monolithic programs.

### 1. Data Reduction Insights

Recognizing that the frequent execution of the same specialized programs generates a substantial volume of unnecessary logs, characterized by the creation of numerous subjects with consistent data dependencies, the inventors leveraged LINUX®'s design philosophy to merge those duplicate logs while preserving the information flow essential for accurate attack detection. Example embodiments start by merging duplicate subjects that execute the same programs.

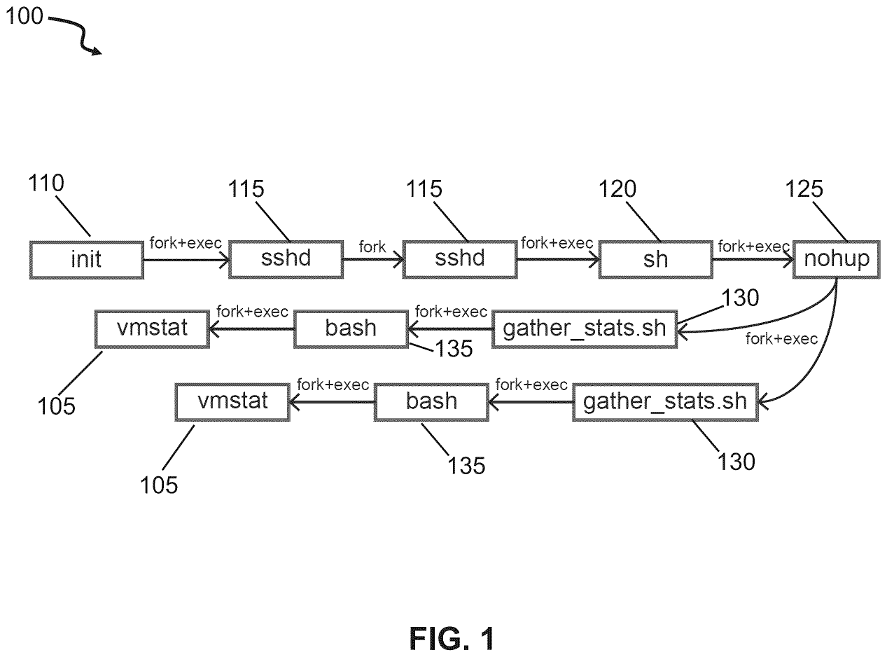

FIG. 1 is a schematic diagram of an example execution sequence.

Broadly speaking, subjects (e.g., processes) represent instances of programs being executed to carry out tasks. They collectively form a hierarchical structure, with a root subject typically identified by PID=1. For any specific subject within this structure, its ancestry is defined as the sequence of subjects that constitutes the tracing path from the root subject to the subject itself. Existing PIDSes use this structure to capture the creation of subjects and establish dependencies. Nevertheless, the inventors observed that many subjects created by executing the same programs exhibit similar ancestries. The ancestries of subjects are considered similar if they encompass the same execution sequence of programs. The inventors used a subject “vmstat” in FIG. 1 to illustrate the execution sequence as follows. FIG. 1 illustrates an example to illustrate the execution sequence using the ancestries of subjects “vmstat” in E3-Cadets. Subjects are denoted by rectangles.

In an example process 100 shown in FIG. 1, the origin of a subject “vmstat” 105 is the root subject operating the “init” 110 program “/sbin/init.” The root subject first spawned a subject to launch the “sshd” 115 daemon by executing “/usr/sbin/sshd.” In other words, the execution of “/usr/sbin/sshd” is initiated by “/sbin/init.” The “sshd” 115 daemon then forked another subject sshd 115 to handle a specific request. Following successful authentication, the subject “sshd” 115 again forked a subject “sh” 120 to execute the shell “/bin/sh.” It then led to the creation of a subject “nohup” 125 that executed the Portable Operating System Interface (POSIX) command “/usr/bin/nohup,” which subsequently triggered the execution of two forked instances of a bash script “/home/darpa/gather_stats.sh” 130, and then a respective subject “bash” 135, eventually leading to the creation of two instances of the subject “vmstat” 105. In short, the ancestry of subject vmstat includes an execution sequence involving the sequential execution of seven programs, including “/sbin/init,” “/usr/sbin/sshd,” “/bin/sh,” /“usr/bin/nohup,” etc.

The inventors' analysis of E3-Cadets revealed that the ancestries of 8,900 subjects “vmstat” share the same execution sequence as described above. For example, FIG. 1 shows the ancestry of two subjects “vmstat,” which both follow the same sequence and were created by invoking the bash script each time. Notably, the ancestries of 220,000 subjects in E3-Cadets disclose 678 distinct execution sequences, involving the frequent execution of 196 programs. 150,000 of these subjects, which execute the aforementioned six commands, only generated 34 different execution sequences. Likewise, 270,000 subjects running 173 programs in E3-Theia revealed 823 different execution sequences, including 49 sequences generated by 52,300 subjects executing “stat” and “sed.” In the inventors' lab environments, 70,000 subjects running 339 programs exhibited 1,267 different sequences, including 171 sequences generated by 22,400 subjects executing “rm,” “cat,” and “sed.”

### 2.2 Intuitive Reduction Design

Inspired by the above analysis, rather than preserving parent-child relationships between subjects, the intuitive design intends to summarize the ancestries of subjects based on their execution sequences. Specifically, we propose a hierarchical structure, termed the profile hierarchy, to derive and organize these execution sequences.

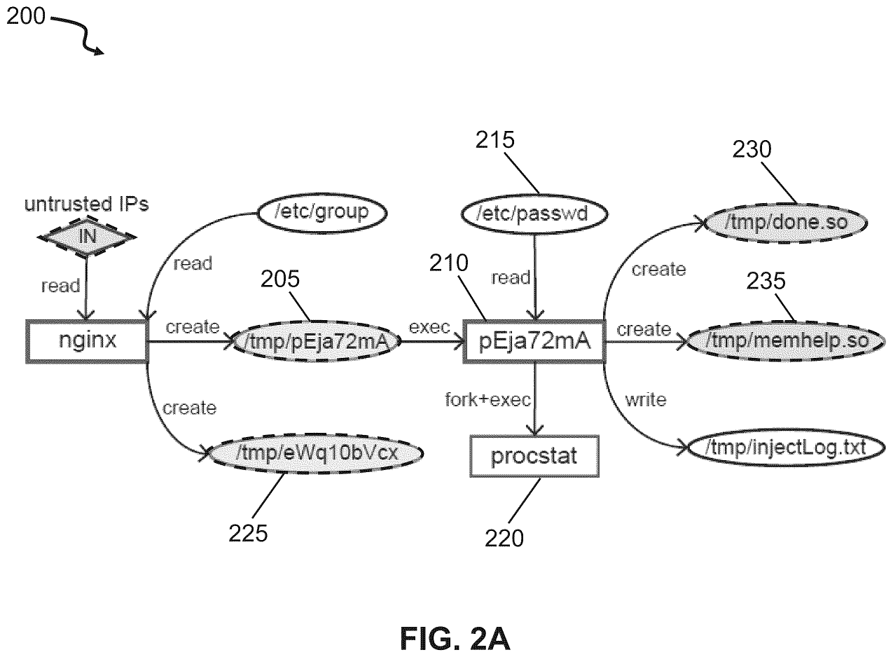

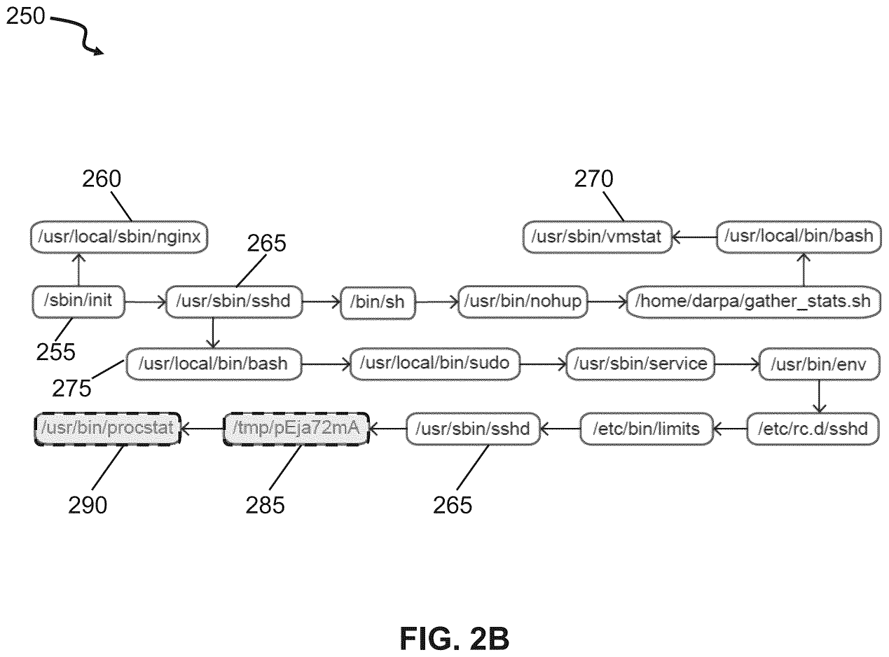

FIG. 2A is a schematic diagram of an example provenance graph. FIG. 2B is a schematic diagram of an example profile hierarchy.

FIGS. 2A and 2B illustrate an example showing a profile hierarchy. FIG. 2A shows an example provenance graph 200 that includes malicious activities of an intrusion/attack scenario. In FIG. 2A, the diamond is an input, ovals represent objects and rectangles represent subjects. Elements with dashed outlines and shading represent malicious items (e.g., malicious files). FIG. 2B shows an example profile hierarchy 250 that summarizes the ancestries of subjects in the attack scenario. Each element in FIG. 2B is designated as a profile node and is represented by a rounded rectangle. Each connecting edge between profile nodes denotes the execution relationship between programs as the arrow directions. Elements with dashed outlines and shading represent malicious items (e.g., malicious files).

The inventors used an APT attack scenario in E3-Cadets to demonstrate the disclosed technique in experiments. This attack exploits a vulnerability in an Nginx web server to establish a foothold on the victim host, enabling the attacker to write malicious payloads on disk, including “/tmp/pEja72 mA” 205 The attacker then executes this payload with escalated privileges and establishes a Command&Control (C&C) channel. Subject “pEja72 mA” 210 reads the credential file “/etc/passwd” 215 and executes command “procstat” 220 to exfiltrate critical information from the victim host. Malicious activities, e.g., shown as objects 205, 225, 230, and 235, were captured in auditing logs and parsed into a provenance graph 200 shown in FIG. 2A. Entities were categorized into subjects (e.g., processes) and objects (e.g., files and/or sockets), such that rectangles denote subjects (e.g., processes) and ovals denote objects (e.g., files and/or sockets). Connections between edges of the entities/elements denote events, which are each shown with a direction by corresponding arrows directed to reflect the information flow and/or causality.

FIG. 2B illustrates an example profile hierarchy 250 that summarizes the parent-child relationships of 13,900 subjects, including three (3) subjects involved in the attack scenario and their ancestries. It should be appreciated that this was an example used in experiments and that embodiments are not limited to these numbers.

In FIG. 2B, the example profile hierarchy 250 starts with an initiating profile “/sbin/init” 255, which branches into two profiles: “/usr/local/sbin/nginx” 260 and “/usr/sbin/sshd” 265. “/usr/local/sbin/nginx” 260 ends immediately without malicious activity, but “/usr/sbin/sshd” 265 branches into two profiles: “/bin/sh” 270 and “/usr/local/bin/bash” 275. The profile “/bin/sh” 275 continues its execution path until profile “usr/sbin/vmstat” 280 without malicious activity, but “/usr/local/bin/bash” 275 has an execution path that creates the malicious profile “/tmp/pEja72 mA” 285, which maliciously calls the profile “/usr/bin/procstat” 290.

Each node in the example profile hierarchy 250 was designated as a profile node ρ and was associated with a program m. A given profile ρ represents an execution sequence \vec{ρ}, which includes a sequence of programs tracing from the root profile to ρ itself. This sequence implies that the execution of program m is ultimately triggered as the outcome of \vec{ρ}. For subjects whose ancestries follow the same sequence \vec{ρ}, they may be associated with profile ρ without retaining their individual ancestries. For example, 8,900 subjects “vmstat” were associated with the profile denoted by “/usr/sbin/vmstat” 270.

Some benefits of the profile hierarchy are as follows:
1. The profile hierarchy effectively summarizes the ancestries of subjects using considerably fewer profile nodes than subjects.
2. The profile hierarchy associates each subject with a profile, allowing for the recognition of duplicate subjects that execute the same programs and share the same execution sequences.
3. The profile hierarchy outlines the execution relationships between programs and facilitates cyber analysts to identify abnormal executions (e.g., “/tmp/pEja72 mA” 285), while reducing false alarms by merging duplicate subjects.

Acknowledging the merits of the profile hierarchy, the disclosed technique can leverage the profile hierarchy to (1) substantially reduce server-side memory overhead at runtime, while (2) ensuring accurate attack detection and forensic analysis.

### System Overview

A core data structure in example embodiments of the present disclosure is referred to as an “access network,” which may be built based on a profile hierarchy. Unlike traditional provenance graphs that faithfully capture all possible dependencies generated by subjects, an access network focuses on consolidating subject dependencies into connections for their associated profiles.

Subjects running the same program, whose ancestries follow the same sequence \vec{ρ}, are likely to conduct consistent activities. As these subjects are associated with the same profile ρ, ρ may be designated represent these subjects and consolidate their activities into its connections. For example, presume that multiple subjects associated with ρ performed a series of “read” operations on file o. The subject may then be merged into a connection from o to ρ with an access type “read.” Such a connection (e.g., between edges in FIG. 2A) is defined as an “access link” for profile ρ, and the connection indicates that some subjects associated with ρ have performed “read” access to file o in history.

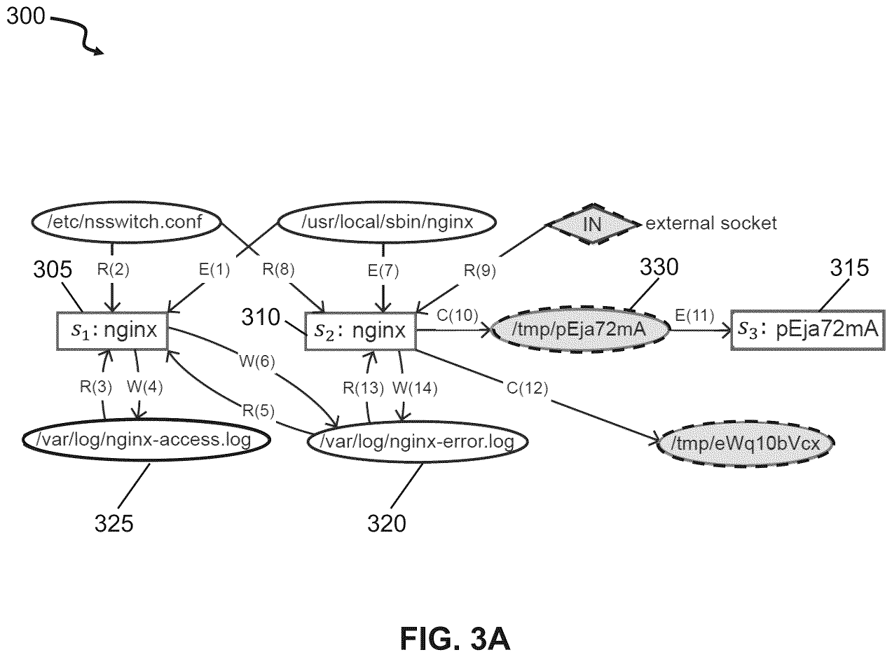

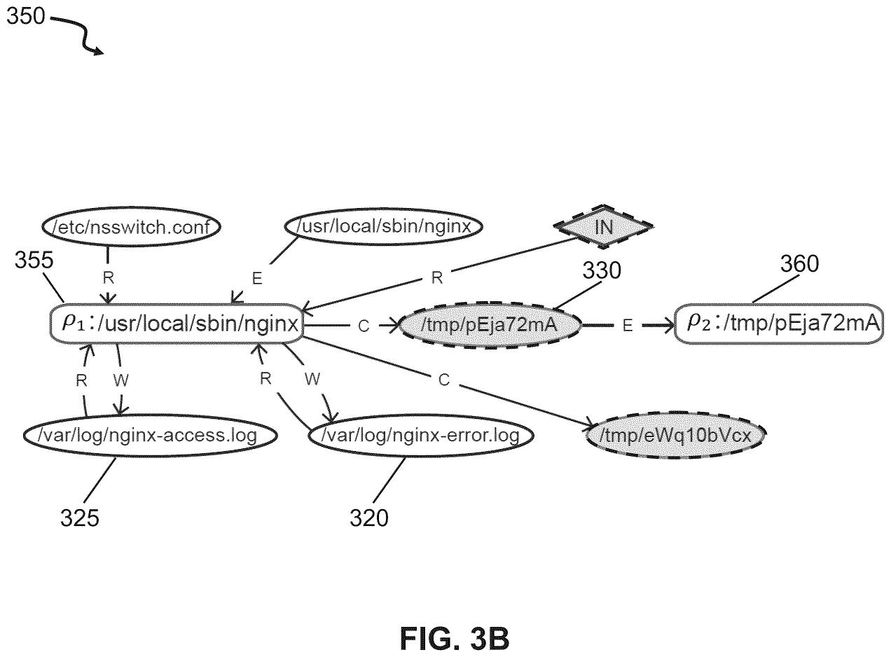

FIG. 3A is a schematic diagram of an example provenance graph. FIG. 3B is a schematic diagram of an example access network.

FIGS. 3A and 3B illustrate an example of a provenance graph 300 used to build an access network 350. In FIG. 3A, an example provenance graph 300 includes operations with timestamps of three subjects: subject 1, s1: nginx (305); subject 2, s2: nginx (310); and subject 3, s3: pEja72 mA (315). Three types of operations were performed during operation: R=Read, E=Execute, W=Write, and C=Create. In FIG. 3B, an example access network 350 is shown that connects each profile with vertices using access links, which are merged from operations of its associated subjects. In other words, the number of “read,” “execute,” and “write,” operations are ignored and the access network 350 simply maps the operation itself without needing to track how many times the operation is called. Subjects “nginx” (305 and 310) and “pEja72 mA” (315) in FIG. 3A are respectively associated with profiles ρ₁ 355 and ρ₂ 360 in FIG. 3B. Elements with dashed outlines and shading represent malicious items (e.g., malicious files).

FIGS. 3A and 3B illustrate an example of a system design used in experiments using the disclosed technique. FIG. 3A depicts the operations performed by three subjects, and FIG. 3B merges these operations into access links for profiles associated with subjects. Because subjects nginx (s₁ and s₂) are associated with profile ρ₁, their operations may be consolidated into access links for ρ₁: “/usr/local/sbin/nginx” 355, such as the “read” and “write” links to “/var/log/nginx-error.log” 320. Each access link is aligned with the direction of information flow and annotated with the access type, as shown by arrows.

The disclosed design can substantially reduce log size. For example, in an experimental case of 150,000 subjects executing six commands in E3-Cadets, which generated over 1.6 million events, the access network consolidated these events into 361 distinct access links (i.e., a reduction by 4,400 times) across 34 profiles. Likewise, in an experimental case of E3-Theia, 52,300 subjects executing “stat” and “sed” generated 1 million events, which the access network consolidated into 452 access links (i.e., a reduction by 2,330 times) across 49 profiles.

### Ensuring Detection Accuracy

One rationale for enabling attack detection leveraging the access network is that APT attacks typically involve a series of causally connected malicious activities within provenance graphs. As malicious activities are combined into access links for profiles, it can be observed that access links merged from attack activities are also coordinated within the access network. For example, in FIG. 3B, profile ρ₂ is transitively connected with profile ρ₁ through the “create” and “exec” links to “/tmp/pEja72 mA” 330, which indicate the origin of this malicious execution. We ensure detection accuracy from the following aspects.

First, the access network can be used to investigate alarms triggered by existing event-matching rules, as will be discussed in detail below. When a symptom event triggers an alarm, the alarm may be associated with the access link merged from that event. An access link is thus considered as “malicious” when malicious activities are merged into it. Additionally, each access link can accumulate alarms when multiple events merged into it trigger similar alerts, which may mitigate “alert fatigue” problems.

Second, to correlate alarms through the coordination of access links while reducing false positives, example embodiments may reconstruct the dependencies between these links. As will be described in detail below, it may be considered that the access link zᵢ becomes dependent on another link zⱼ when operations merged into zᵢ have historically shown direct dependence on operations merged into zⱼ. For example, presume that subject s, associated with profile ρ, performs a series of “write” and “read” operations. These operations are merged into a “write” link zᵢ and a “read” link zⱼ for ρ. In this case, zᵢ is considered dependent on zⱼ as far as the latest “write” operation is dependent on the earliest “read” operation.

Standard auditing frameworks offer coarse-grained data provenance, meaning that every output operation performed by the subject is dependent on every preceding input operation of the same subject. Example embodiments establish dependencies for access links by preserving the essential information flow generated by subjects. By building dependencies for access links, the access network according to example embodiments achieves detection accuracy comparable to existing PIDSes, while incurring a significantly smaller memory overhead.

### System Design

### 1. The Profile Hierarchy

### A. Definition

The execution sequence serves as the key component of the profile hierarchy to summarize the ancestries of subjects. An execution sequence may be denoted as \vec{ρ}, where \vec{ρ}=[m₀, m₁, m₂, . . . , mₙ]. The execution sequence signifies that the root subject operating the “init” program m₀, first spawns subjects to execute program m₁ through “exec” system calls (“syscalls”), which in turn executes m₂ and continues in this manner, with each program initiating the execution of the next, ultimately leading to the execution of mₙ. |\vec{ρ}|=mₙ may be used to indicate the execution outcome of \vec{ρ}. In some cases, programs within an execution sequence can be the same, such that mᵢ=mⱼ and i≠j. This occurs when a program is executed more than once within the sequence. For instance, program “/usr/sbin/sshd” 265 appears twice within the execution sequences in FIG. 2B, which is why both instances have the same label “265.” The program may be a binary or an executable (e.g., PYTHON® or Bash script) with a unique pathname to differentiate it from others on the host. The unique pathname typically specifies the program's location from the root directory.

For each execution sequence \vec{ρ}, a profile node ρ may be defined. Profile ρ may be denoted by a 2-tuple, [symbol] \vec{ρ}, |\vec{ρ}| [symbol] , where |\vec{ρ}| denotes the last program mₙ in \vec{ρ}. Profiles jointly form the profile hierarchy P. Given a profile ρₑ in P, it may be specified that ρₑ is a child profile of ρ when ρₑ=\vec{ρ}+|\vec{ρ}ₑ|, where |\vec{ρ}ₑ| is appended at the end of \vec{ρ}. The expression signifies that \vec{ρ} leads to the initialization of \vec{ρ}ₑ by executing program |\vec{ρ}ₑ| at the end of itself. The edge from ρ to ρₑ may be defined to be annotated with the access type “initiate.” The execution sequence of the root profile ρ may be defined as \vec{ρ}=[m₀], where m₀ is the “init” program, such as “/sbin/init” (265 in FIG. 2B) or “/lib/systemd/systemd” in LINUX®.

### B. Real-Time Construction

To facilitate the construction of the profile hierarchy in an online setting, example embodiments may introduce an auxiliary hierarchical structure, referred to as a “subject tree.” Each subject tree maintains records of active subjects on a host, with the root element denoting the root subject. Each newly created subject on the host is added as a child element under its parent subject within the subject tree and is removed upon its termination.

The events of interest include the “exit,” “exec,” and “fork” system calls. The “exit” signals the termination of a subject, while “exec” and “fork” signal the execution of a program and the creation of a subject, respectively. Let the subject tree S be initialized with the root subject s, which is associated with the root profile ρ within the profile hierarchy P. Algorithm 1 below is an example construction of the profile hierarchy. Algorithm 1 outlines the rules for handling each type of events to derive the execution sequence of each active subject using the subject tree.

Algorithm 1 Construction of the Profile Hierarchy

| Require: E is event stream sorted by start time in asc. order | |
|---|---|
| 1: | for each e in E do |
| 2: | if e is exec(s, m) event then |
| 3: | ρ ← S[s].profile, return ρ associated with s |
| 4: | ρₑ ← [symbol] \vec{ρ} + m, m [symbol] , define ρₑ as a profile node in P |
| 5: | S[s].profile ← ρₑ, associate s with ρₑ |
| 6: | P ← P + edge(ρ, ρₑ, initiate) |
| 7: | else if e is fork(s, sₑ) event then |
| 8: | sₑ ← CopySubject(s) |
| 9: | S ← S + edge(s, sₑ) |
| 10: | else if e is exit(s) event then |
| 11: | S ← S \ {s}, delete s from S |
| 12: | end if |
| 13: | end for |

Each profile ρ may be considered as a specific execution context that aggregates the activities of subjects, whose ancestries share the same sequence \vec{ρ}. The “fork” event copies the profile associated with the parent subject to its child (e.g., line 8 in Algorithm 1), as their ancestries share the same sequence. Conversely, the “exec” event switches the subject's profile based on the program being executed (e.g., lines 3-6 in Algorithm 1). The subject tree S acts as a database that records the profiles associated with active subjects, thereby enabling the identification of execution sequences for newly created subjects at runtime. The subject tree imposes a constant but minimal storage overhead over time, especially when compared to the extensive number of subjects present in existing PIDSes.

### 3. Limitations

The limitations of the profile hierarchy in real-world scenarios and their mitigation are discussed below.

A. Tracing Back to “init”

Some essential services (e.g., the “sshd” daemon, for example, 115 in FIG. 1) start before the activation of standard auditing frameworks due to the boot sequence. As a consequence, the ancestries of subjects operating these services are not captured in auditing logs, leading to the incorrect ancestries for their following subjects.

To mitigate this, one can acquire the list of active subjects from the host upon system activation, using utilities such as “pstree” in LINUX®. By adding those subjects into the subject tree according to their parent-child relationships, one can then derive the execution sequence of each following subject. This may be considered to be a one-time effort to initialize the system. Note that hosts utilizing whole-system provenance techniques based on LINUX® Security Module (LSM) may not be subject to this limitation.

### B. Missing User IDs

The profile hierarchy captures program invocation relationships without considering the users who own the subjects and initiate the execution, posing challenges for analysts in identifying the user responsible for launching malicious execution.

To tackle this, one can define each profile as a 3-tuple [symbol] \vec{ρ}, |\vec{ρ}|, uid [symbol] , where uid denotes the user ID that owns the subjects associated with ρ. For example, presume that subject s is associated with profile ρ= [symbol] \vec{ρ}, |\vec{ρ}|, uid=1000 [symbol] . In a case in which it generates a “setuid” event to switch its user ID to 80, one can define a profile ρₑ= [symbol] \vec{ρ}ₑ, |\vec{ρ}ₑ|, uid=80 [symbol] and associate s with ρₑ. Note that ρₑ is a copy of ρ with a different user ID (e.g., \vec{ρ}=\vec{ρ}ₑ), and should be added as a sibling node of ρ to the profile hierarchy.

### 2. The Data Model

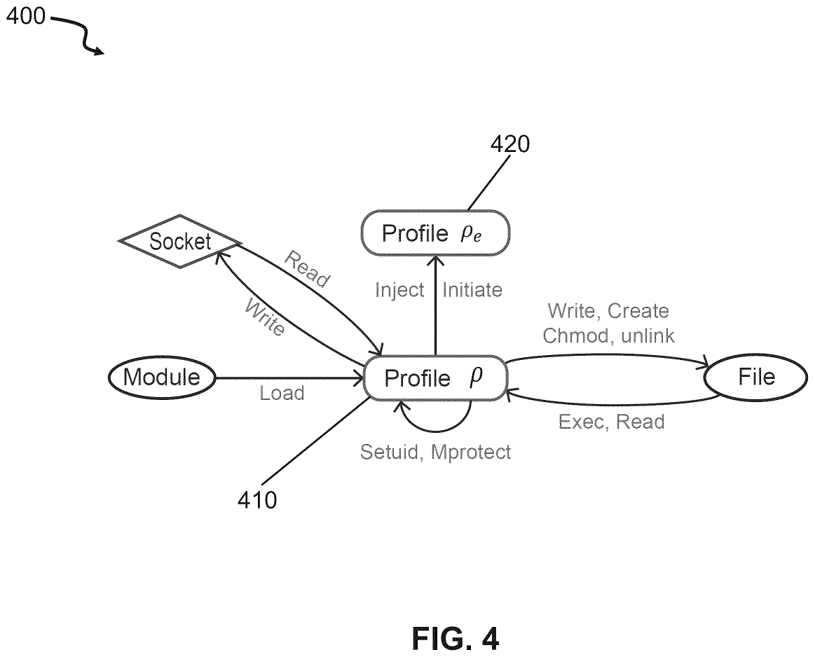

FIG. 4 is a schematic diagram of an example data model.

FIG. 4 shows an example data model 400 in accordance with an example embodiment of the present disclosure. FIG. 4 illustrates the access links that may be constructed for profile ρ (410). In the data model 400 for profile ρ, each edge represents an access link for ρ and is annotated with the access type. Each link z is represented as a 3-tuple [symbol] ρ, v, α [symbol] , where v denotes the vertex being accessed and α denotes the access type. In most cases, each operation can be merged into a single link. However, an exec(s, o) operation of subject s reveals two separate links associated with different profiles. Presume that subject s is associated with profile ρ. It first discloses an “initiate” link z₁= [symbol] ρ, ρₑ, initiate [symbol] to define profile ρₑ (420) by appending file o to the end of \vec{ρ}, where ρₑ= [symbol] \vec{ρ}ₑ, o [symbol] and \vec{ρ}ₑ=\vec{ρ}+o. The operation then reveals an “exec” link z₂= [symbol] ρₑ, o, exec [symbol] for ρₑ, as ρ of s transitions to ρₑ.

For security-relevant operations, such as “mprotect,” with varying permissions performed by subjects associated with the same profile ρ, these operations may be merged into a single link z for ρ, while preserving the highest level of permissions among them.

### 3. Determining Dependencies

The access network may create access links for profiles by merging operations without considering their dependencies, which may result in spurious dependencies. For example, given the links of profile ρ₁ (355) in FIG. 3B, it is unclear whether the create link to “/tmp/pEja72 mA” 330 is dependent on the read link to “/var/log/nginx-access.log” 325, despite the fact that the operations merged into them were performed by different subjects associated with ρ₁. To mitigate such errors, the inventors contemplated rebuilding dependencies for links from the following aspects.

### A. Scenario 1

This scenario considers that individual subjects associated with the same profile ρ may perform different operations, resulting in different links with different dependencies for ρ. The objective is to sort these dependencies by analyzing the relationships between operations of the same subject.

Recall that an output operation is dependent on every preceding input operation of the same subject. Presume that an active subject s inside the subject tree, associated with profile ρ, conducts a series of operations that can be merged into the same link z for ρ. We let s record the latest timestamp for z when z is an output link merged from output operations (e.g., “write”). Conversely, s retains the earliest timestamp for z when z is an input link merged from input operations (e.g., “read”).

Given a list of links Zₛ merged from input and output operations of subject s, where Zₛ=[z₁, . . . , zₙ], subject s determines the dependency relationships among Zₛ upon its termination. For example, subject s first sorts Zₛ by their timestamps in ascending order. Each output link zₒ may be considered dependent on every preceding input link zᵢ within Zₛ. In a case in which operations from different subjects associated with ρ show different dependencies for the same output link zₒ, these dependencies may be combined into a unified set for zₒ. Afterward, subject s may be removed from the subject tree S.

### B. Scenario 2

This scenario considers dependencies between access links to the same object, such as the “exec” and “create” links to “/tmp/pEja72 mA” 330 in FIG. 3B.

In data provenance, an input operation on an object is dependent on every preceding output operation on the same object. Following this principle, for an input link z; and an output link zₒ on the same object, the latest timestamp for zᵢ may be recorded among operations merged into input link zᵢ. Conversely, the earliest timestamp for zₒ may be recorded. The link zᵢ may be determined to be dependent on zₒ when its associated timestamp is later than that of zₒ. Operations merged into the same link on an object can be performed by different subjects associated with the same profile. The objective of this scenario is to measure the likelihood of profiles being transitively connected through access links on a specific object.

### C. Scenario 3

Dependencies for other types of access links may also be considered. First denote that the “initiate” link z= [symbol] ρ, ρₑ, initiate [symbol] becomes the dependency of every link of profile ρₑ. A “fork” event copies the timestamps for access links in Zₛ from the parent subject to its child. An “exec” clears the memory of s, and Zₛ is removed from the subject within the subject tree.

For access links merged from security-relevant operations, such as “setuid” or “mprotect,” Scenario 1 can be used to determine dependencies. For instance, presume that subject s performs a series of “read” operations and “mprotect” operations, which are merged into a “read” link and an “mprotect” link, respectively. In this case, the “mprotect” link can be considered as an output link to determine its relationship with the “read” link.

### 4. Detection Strategies

Provenance-based intrusion detection using system logs has been well-demonstrated. A key contribution of the disclosed technique lies in its capability to detect APT attacks by analyzing the connectivity between access links. For example, example embodiments may enable attack detection through the access network, leveraging existing event-matching rules from sources such as the MITRE ATT&CK® knowledge base.

Example embodiments may generate alerts by applying event-matching rules to streaming events. When an alert triggered by a specific event, it may be associated with the access link merged from that event. Because APT campaigns often generate numerous alerts, causing “alert fatigue” as analysts need to investigate them individually, access links can be used to accumulate alerts. Presume that each alert is assigned with a specific “weight” value, for example, in a range of (0.0,1.0), reflecting its confidence level, although embodiments are not limited to this range example. In some example embodiments, a stress score may be accumulated until it reaches a threshold. When multiple events generate alerts and these events can be merged into the same access link, this link may accumulate the weights of these alerts.

To prioritize attack investigation, each profile may aggregate the weights accumulated by its associated links, which may be merged from operations of its corresponding subjects. This enables analysts to begin investigating attacks from the profile with the highest cumulative weight. The forward and backward searches from this starting point can be conducted through the access network, following dependencies between links established above. The detection performance of the access network using detection techniques proposed in HOLMES is discussed below.

### Experimental Evaluation

Threat Model: The inventors presumed that the enterprise is benign at its outset, implying that attacks initially originate from external sources. The system collected auditing logs from each host using standard auditing frameworks, such as the LINUX® Audit Subsystem (LAuS) and “dtrace” for FREEBSDR. The inventors considered the operating system (OS) kernel and the auditing frameworks as components of the trusted computing base (TCB).

Implementation: The system under attacks included multiple hosts running Ubuntu LINUX® and FREEBSD®. The analysis was performed on an UBUNTU® 20.04 LINUX® Workstation with INTEL® 3.60 GHz XEON®-Gold-5122 CPU and 192 GB memory.

### 1. DARPA Dataset

The inventors primarily used LINUX®-based datasets released by DARPA Transparent Computing Program, Engagement 3 and 5, including FREEBSD®-based Cadets hosts as well as UBUNTU®-based THEIAR and Trace hosts. Datasets in Engagement 3 are referred to as “E3-Cadets,” “E3-Theia,” and “E3-Trace,” and datasets in Engagement 5 are referred to as “E5-Cadets,” “E5-Theia,” and “E5-Trace.” These datasets were collected from adversarial engagements that simulated real-world APT campaigns on enterprise networks. Each simulation lasted over 10 days, during which a red team launched a series of attacks targeting security-critical services (e.g., web browsers and secure shell (SSH) servers), while a blue team deployed auditing frameworks to capture both malicious and benign activities.

To evaluate the reduction performance of the disclosed technique across diverse environments, the inventors simulated “ShellShock” attacks against vulnerable webservers in our LINUX®-based lab environments as detailed in Section 6.4. For other public datasets, Stream Spot lacks semantic information for log entries and entities involved. Unicorn utilizes the LINUX® Security Module (LSM) to capture logs, which collect enormous interactions between kernel objects. The inventors therefore excluded these datasets from our evaluation. WINDOWS®-based datasets, such as DARPA Operationally Transparent Cyber (OpTC) will be discussed below.

Data from DARPA TC Engagement 3: According to the ground truth, E3-Cadets contains four Nginx backdoor attacks. E3-Theia includes one Firefox backdoor attack. E3-Trace includes five attacks, including a Firefox backdoor, a Browser extension, a Phishing executable, a Pine backdoor, and a Phishing email link attack. However, because there are no subsequent effects on the victim host after visiting the phishing website, the last attack is not visible in system-level logs. The inventors thus omitted this attack from their analysis.

Data from DARPA TC Engagement 5: E5-Cadets were collected from three hosts. These hosts underwent the same attacks and generated similar results. The inventors presented the results of a single host, TC5-Cadets-1. “E5-Cadets” refers to logs from TC5-Cadets-1″ Similarly, “E5-Trace” refers to logs from TC5-Trace-1, and “E5-Theia” refers to TC5-Theia-1.

The attacks in TC5 were initiated using trusted IP addresses or pre-existing malware. For instance, the malicious HTTP posts originated from IP addresses within the same network as the victim host. The inventors then presumed that the enterprise deploys intrusion detection systems (IDS) capable of raising alerts when subjects read/load from these sources.

### 2. Reduction Analysis

The inventors first evaluated the reduction performance of the access network using DARPA datasets. The evaluation was conducted from three aspects: first, by analyzing the reduction in the number of nodes achieved through summarizing subject ancestries into the profile hierarchy; second, by analyzing the reduction in the number of edges achieved through the access network, compared to all dependencies generated by subjects in provenance graphs; and third, by comparing the reduction performance of the access network against state-of-the-art reduction techniques.

### A. Reduction Analysis of the Profile Hierarchy

Table 1 is a reduction analysis of the profile hierarchy, and shows the number of profiles merged from subjects in each DARPA dataset. The last column indicates the number of programs being executed. On average, the profile hierarchy aggregates subjects in DARPA TC3 by 300 times, while achieving a reduction of over 2,000 times in DARPA TC5.

TABLE 1

| Dataset | #Subjects | #Profiles | #Programs |
|---|---|---|---|
| E3-Cadets | 224,000 | 678 | 196 |
| E3-Theia | 279,000 | 823 | 173 |
| E3-Trace | 367,000 | 1,369 | 197 |
| E5-Cadets | 2,300,000 | 898 | 184 |
| E5-Theia | 1,200,000 | 948 | 274 |
| E5-Trace | 4,100,000 | 1,045 | 257 |

Some notable details are discussed below.
E3-Trace: 190,000 subjects were spawned to execute commands, such as “dpkg,” with their ancestries identifying 60 profiles. Additionally, 80,000 subjects running “firefox” are associated with two profiles.
E5-Cadets: 880,000 subjects were spawned to execute commands “cc” and “sed,” which created 16 profiles.
E5-Theia: 510,000 subjects were created to execute command “/usr/bin/stat,” leading to the identification of 11 profiles.
E5-Trace: Included 1,700,000 subjects running “pulseaudio,” which were associated with two profiles. In addition, over 2,320,000 subjects were spawned to execute various commands and associated with 64 profiles. Notably, 36 out of these profiles were each associated with 23,800 subjects, as the programs were periodically invoked by the host.

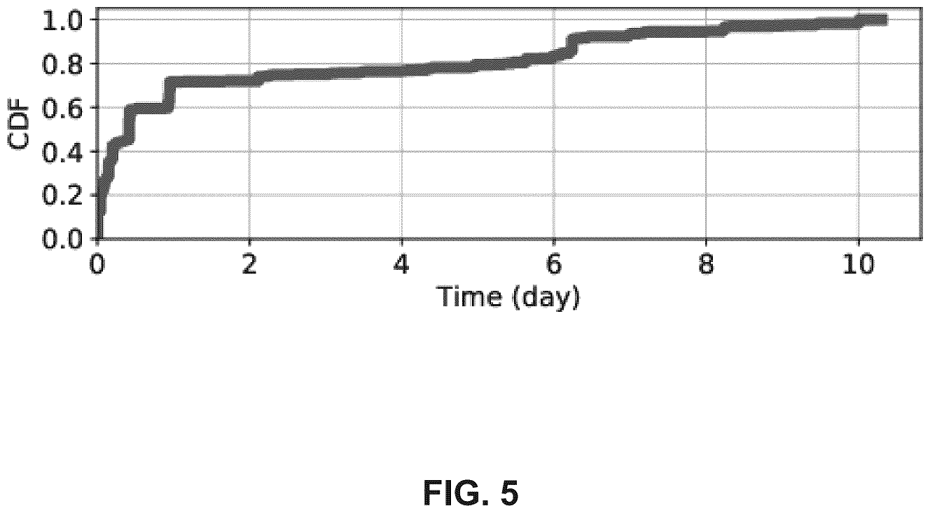

FIG. 5 is a graph of a cumulative distribution function (CDF).

The majority of these subjects were created as part of routine system tasks. Their consistent activities are generally irrelevant to attack detection, while the profile hierarchy effectively identifies and aggregates them based on their execution sequences. FIG. 5 shows the cumulative distribution function (CDF) of new profile creation (e.g., generating profile nodes) over time in E3-Trace. During the 10-day simulation, about 70% of the profiles were created on the first day, with the majority being identified due to the system initialization.

The inventors excluded the subject units and their events in Trace systems from their analysis, as these appeared to be application-level activities, such as the behaviors of individual tabs in the FIREFOX® web browser running as “firefox.” For subjects that lack creation events (e.g., “fork” and “exec”), the inventors inferred their associated profiles based on the profiles of their parent subjects and, if applicable, their executable names.

### B. Reduction Analysis of the Access Network

Table 2 is an overview of the reduction achieved by the access network, and presents the reduction in the number of edges achieved by consolidating subject dependencies into access links. For each dataset, the second column indicates the number of events merged by the access network. These events were merged into the number of links listed in the third column, with the reduction achieved in the fourth column. The remaining columns show the distributions of events along with the reduction achieved by the access network.

TABLE 2

| | | | | The reduction rate of each access type | | | | | | | |
|---|---|---|---|---|---|---|---|---|---|---|---|
| Dataset | #Events | #Links | Reduc | Read | Reduc | Write | Reduc | Exec | Reduc | Others | Reduc |
| E3-Cadets | 19M | 636K | 29.9x | 87% | 27.6x | 9% | 205x | 2% | 716x | 2% | 14.1x |
| E3-Theia | 74M | 987K | 75.8x | 20% | 26.2x | 5% | 16.6x | 0.2% | 145x | 75% | 298x |
| E3-Trace | 31M | 1.11M | 27.3x | 51% | 23.3x | 8% | 128x | 2% | 234x | 39% | 28.1x |
| E5-Cadets | 201M | 6.02M | 33.4x | 75% | 40.7x | 18% | 23.5x | 2% | 4,665x | 5% | 12.5x |
| E5-Theia | 144M | 3.12M | 46.3x | 76% | 50.5x | 15% | 22.9x | 1.5% | 2,743x | 7.0% | 2,308x |
| E5-Trace | 868M | 3.96M | 219x | 81% | 302x | 10% | 717x | 0.9% | 3,888x | 8.6% | 49.2x |

Remarkably, the access network reduced the number of edges in E5-Trace by 219 times. The reduction in E5-Trace was primarily attributed to events of a subject “Xvnc4,” where “Xvnc4” is a Virtual Network Computing (VNC) system used for remote control. 70% of the “read” operations and 73% of the “write” operations in E5-Trace were performed by this subject on the file “/tmp/.X11-unix/X1,” and these operations were consolidated into a “read” link and a “write” link, respectively. By excluding these operations, the access network yielded a reduction of 79 times in E5-Trace. For THEIAR hosts, the access network reduced the number of other events (excluding “read,” “write,” and “exec”) by over two orders of magnitude, with 99% of these events being “mprotect.”

For each “read,” “write,” and “create” event, the inventors merged the event into an access link if it operated on a file or a network socket. In E3-Trace, the dataset initially included 726 million (M) events, with the majority of “read” and “write” operations targeting other objects, including 229 million source-sink objects and 16 million unspecified objects. To accurately examine the performance of the access network, the inventors excluded these events from the evaluation. As a result, 31 million out of 726 million events in E3-Trace were eligible for reduction analysis.

C. Disclosed Technique vs. State-of-the-Art

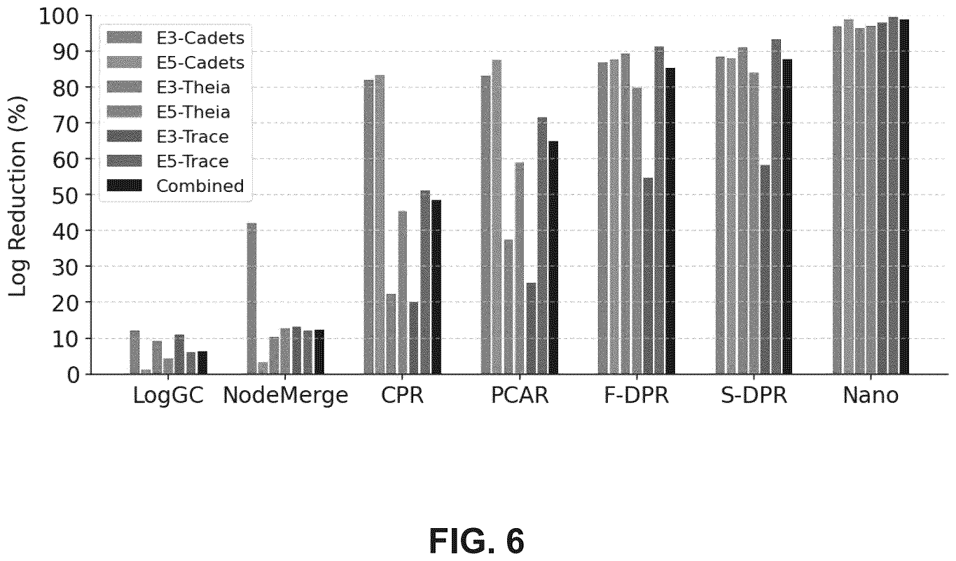

FIG. 6 is a graph of experimental results.

To demonstrate the space efficiency of the disclosed technique, the inventors compared its log reduction performance with known state-of-the-art reduction techniques, including Log Garbage Collection (LogGC), Node Merge Reduction (NodeMerge), Provenance-based Causality Reduction (PCR), Provenance-based Causality and Activity Reduction (PCAR), Full Data Provenance Reduction (F-DPR), and Semantic Data Provenance Reduction (S-DPR). For example, the inventors re-implemented these techniques using source codes provided by prior research efforts that evaluated the log size reduction of these techniques and their combined effectiveness. In FIG. 6, log reduction percentages are shown for individual techniques using LINUX®-based DARPA datasets. FIG. 6 reports on the log size reduction of individual techniques using the aforementioned six DARPA datasets.

The disclosed technique, denoted as “Nano” in FIG. 6, achieved the highest overall log reduction, reducing log size by 98.8% when combining all datasets, while the most aggressive among existing techniques, S-DPR, achieved a total reduction of 87.6%. Note that S-DPR identifies redundant events through a global graph operation, as it is designed to remove events that are not necessary for correctly traversing entity ancestors during backward and forward tracing. In contrast, the disclosed technique consolidates duplicate logs from subjects that originate from the same execution sequences with zero graph traversal overhead.

PCAR was also free of graph operations because it was designed to remove I/O events that do not alter forensic values between entities, achieving a total log reduction of 64.9%. NodeMerge reduced log size by 12.3%, and it needed a training phase to conservatively recognize read-only files. LogGC reduced log size by 6.3%, with its peak performance heavily relying on extensive software instrumentation, which was not implemented in the inventors' experiments.

### 3. Detection Performance

The inventors evaluated the detection accuracy of the access network using event-matching rules and threat scoring algorithms proposed in prior works, such as HOLMES, NoDoze, and RapSheet. For example, in experiments, the inventors adopted methods in HOLMES, as it represents one of the most effective rule-based detection techniques. HOLMES defines a set of detection rules based on tactics, techniques, and procedures (TTPs) related to APT behaviors and categorizes them into seven stages of the APT kill chain, including “Initial Compromise,” “Establish Foothold,” etc. These rules were applied to streaming events to characterize attack behaviors when multiple alarms were triggered within the same event stream. Alarms may be associated with access links, which consolidate the events that trigger them. Example embodiments may then evaluate whether alarms from a coordinated set of access links indicate an unfolding APT campaign.

To achieve this, the inventors calculated the overall threat score for each coordinated set of access links. For example, each rule was assigned a specific value that reflects its severity. For instance, the “UntrustedFileExec” alarm, which signals the execution of an untrusted file, falls under the “Initial Compromise” stage and is assigned a severity score of 10. The “ShellExec” alarm, which indicates shell execution associated with information flow from untrusted IP addresses, falls under the “Establish Foothold” stage and is assigned a severity score of 6. Given alarms associated with a coordinated set of access links, they are first mapped into their respective stages. The overall threat score for this set of links may then be calculated by combining the highest severity from each stage using equation

$$TS = {\prod }_{i = 1}^{7} {( {S}_{i} )}^{{ω}_{i}} ,$$

where Sᵢ denotes the highest severity in stage i and ωᵢ is the weight assigned for that stage.

Table 3 below shows threat scores assigned to each attack scenario. By tracing through the access network in each dataset based on the established dependencies, Table 3 summarizes the threat scores for malicious access links that describe attack scenarios, alongside the highest scores from benign links. Notably, the threat scores for attacks in E3-Cadets and E3-Trace, calculated from their access networks, are very close to those reported in other works. This indicates that the access network generated using the disclosed technique effectively preserved the forensic values of attacks while significantly reducing log size. Attacks in E5-Cadets and E5-Trace share the same scores as both attacks triggered the same set of alarms, including “MakeMemExec,” “ShellExec,” “SensitiveRead,” “Escalate,” etc.

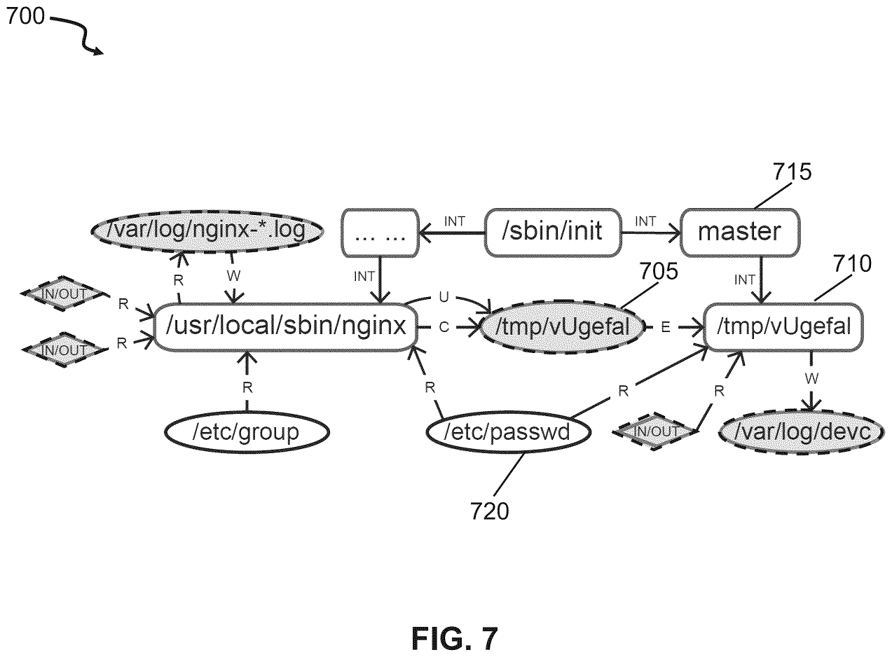

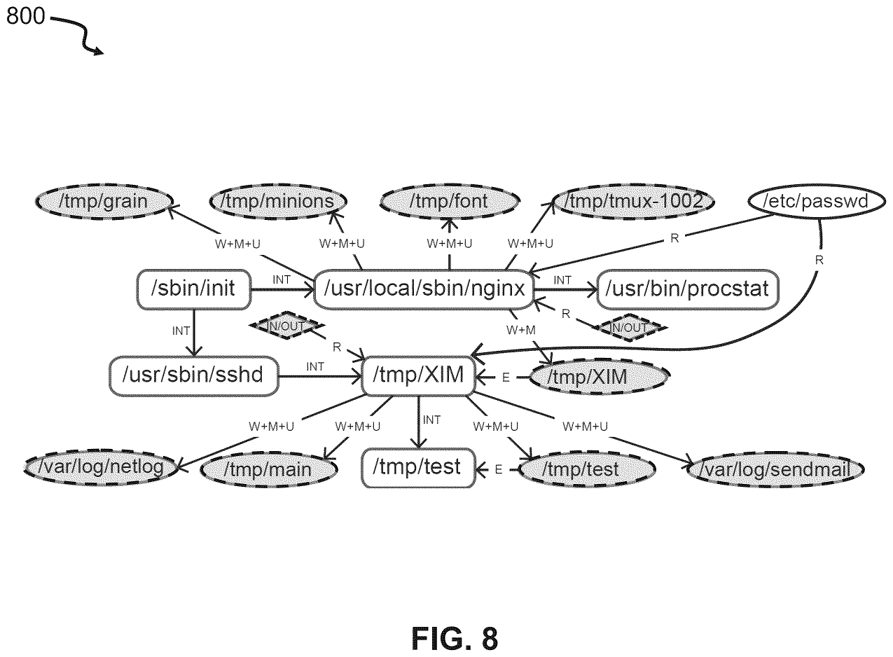

TABLE 3

| Dataset | Attack Scenario | Threat Score | Highest Benign Score |
|---|---|---|---|
| E3-Cadets | Nginx backdoor in | 3,107,891 | 3,375 |
| | FIG. 7 | | |
| | Nginx backdoor in | 4,649,220 | |
| | FIG. 8 | | |
| E3-Trace | Firefox backdoor | 314,862 | 5,049 |
| | Browser extension | 1,163,881 | |
| | Phishing executable | 36,995 | |
| | Pine backdoor | 55,342 | |
| E3-Theia | Firefox backdoor | 21,091 | 1,132 |
| E5-Cadets | Nginx Drakon APT | 471,015 | 16,908 |
| E5-Trace | Firefox Drakon APT | 471,015 | 11,303 |
| E5-Theia | Firefox Drakon APT | 29,656 | 11,302 |

By evaluating these threat scores, the inventors observed that setting the threshold within the interval [16908, 21091] yielded 100% accuracy and recall across datasets. This indicates that the disclosed technique can effectively distinguish coordinated sets of access links related to attack activities. However, such thresholds may lead to false negatives when detecting attacks with fewer APT stages, such as a Remote Access Trojan (RAT) attack and the CCleaner ransomware, which only triggered alarms that fall into the “Initial Compromise,” “Establish Foothold,” and “Cleanup Tracks” stages (e.g., a threat score of 608). The inventors were unable to evaluate them, as the RAT attack was simulated on WINDOWS® systems and the CCleaner ransomware was simulated in non-public DARPA TC Engagement 4 in the prior studies.

Alternatively, the inventors observed that the few elevated benign scores are often attributed to applications like “sshd” daemons and web servers when system administrators access them via untrusted external sockets. To mitigate this, one prior study introduced a training phase to reduce elevated noise levels. This phase has been shown to lower the highest benign scores for such benign activities to 338. Therefore, setting a threshold above 338 may help detect the above attacks while reducing false positives.

FIGS. 7-10 are schematic diagrams of experimental results for access networks.

Detection Details: The detection details of attacks in TC3 datasets may be discussed using the access network. For conciseness, the discussion of attacks in TC5 is omitted. “R” represents a “read” event, “W” represents a “write” event, “C” represents a “create” event, “U” represents an “unlink” event, “M” represents a “chmod” event, “E” represents an “exec” event, and “INT” represents an “initiate” event in FIGS. 7-10.

E3-Cadets Dataset: FIG. 7 illustrates an access network 700 of a first Nginx backdoor. The access network 700 was generated from E3-Cadets and describes the first “Nginx” backdoor attack. After exploiting “nginx,” the attacker downloaded the malicious payload object “/tmp/vUgefal” 705, which was executed, triggering an “UntrustedFileExec” alarm. The execution of profile “/tmp/vUgefal” 710 was initiated by an executable profile, named “master” 715. However, E3-Cadets does not specify the information about “master” 715. Profiles denoted by “nginx” and “vUgefal” triggered several “SensitiveRead” alarms, as their subjects conducted read access to “/etc/passwd” 720. FIG. 8 illustrates an access network 800 of other “Nginx” attacks in the E3-Cadets dataset. In FIG. 8, the access network 800 is shown from E3-Cadets that describes additional “Nginx” backdoor attacks. In these attacks, the attacker downloaded nine malicious payloads, most of which were executed. The attacker also controlled subjects “nginx” to perform port scanning.

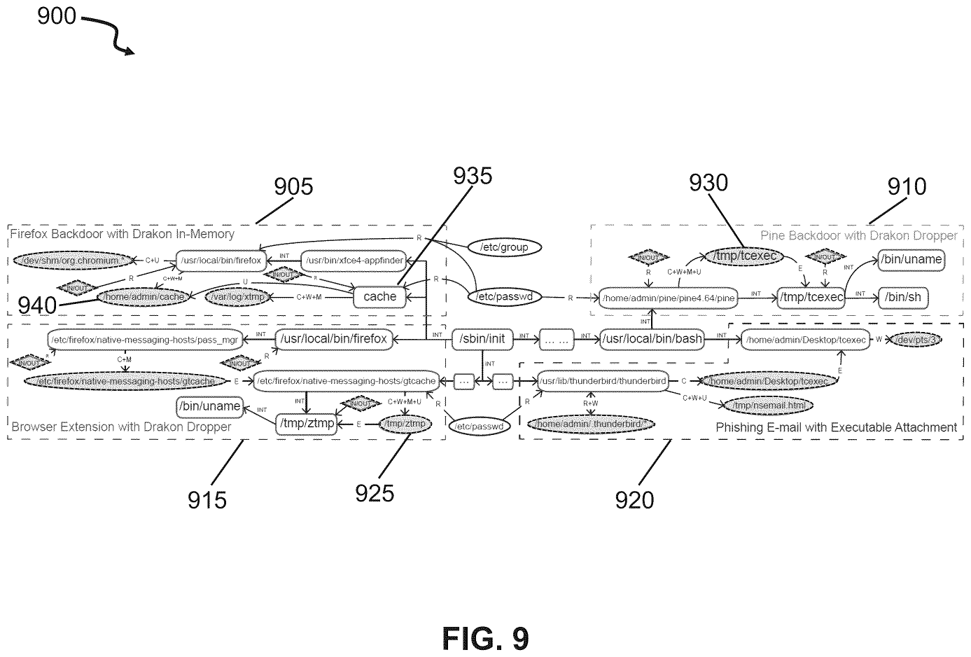

E3-Trace Dataset: FIG. 9 shows an access network 900 that included four attacks 905, 910, 915, 920 in E3-Trace. The access network 900 includes access links merged from malicious activities of four attacks in E3-Trace. The access network triggered four “UntrustedFileExec” alarms (e.g., the execution of files “/tmp/ztmp” 925 and “/tmp/tcexec” 930) and several “ShellExec” alarms. In the case of the FIREFOX® backdoor with Drakon in-memory, the profile denoted by “cache” 935 is considered to be related to the attack because it removed the malicious payload “/home/admin/cache” 940 downloaded by “firefox.” However, E3-Trace does not specify whether the profile “cache” 935 was created due to the execution of “/home/admin/cache” 940.

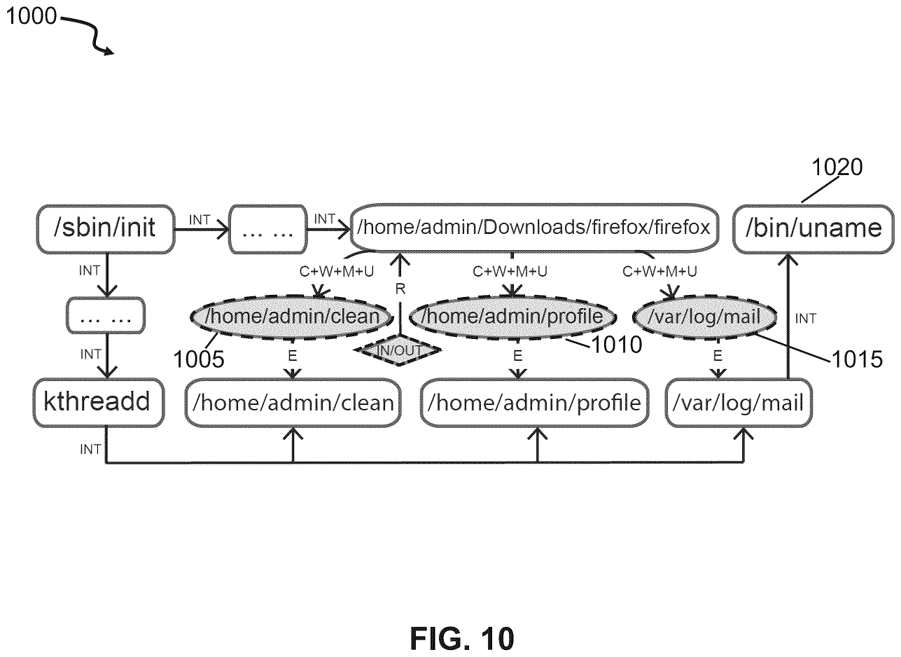

E3-Theia Dataset: FIG. 10 shows an access network 1000 of a “firefox” backdoor attack in E3-Theia. The attack triggered “UntrustedFileExec” and “Escalate” alarms by executing objects “/home/admin/clean” 1005, “/home/admin/profile” 1010, and “/var/log/mail” 1015 with escalated privileges. These malicious payloads were initially downloaded through the exploits against “firefox.” The subject running “/var/log/mail” 1015 also executed “uname,” e.g., at profile “/bin/uname” 1020.

### 4. Analysis Across Environments

Lab Environments: DARPA datasets may include synthetic background events generated through periodic execution of workload scripts, such as the recurring execution of commands observed in E3-Cadets and E5-Trace. To evaluate the performance of the disclosed technique in diverse environments, the inventors simulated real-world APT attacks and collected logs from their lab environments for 12 days. During the simulation, users on the host conducted normal activities, including browsing websites and analyzing various documents. In the meantime, the inventors simulated “ShellShock” attacks targeting an APACHE® webserver (CVE-2021-42013). No recurring execution of scripts was intentionally deployed during the simulation. Table 3 below summarizes a simulated reduction analysis of the top 3 applications (“/usr/bin/top,” “python3.9,” and “VirtualBox”) in the inventors' lab environments by the number of events, along with the reduction rates achieved by the disclosed technique.

TABLE 4

| Application | % Events | % Links | Reduc |
|---|---|---|---|
| /usr/bin/top | 83% | 5.6% | 34,000x |
| python3.9 | 11% | 3.2% | 8,000x |
| VirtualBox | 2.6% | 1.2% | 5,200x |

The simulation collected 530 million events generated by 70,000 subjects. As mentioned above, these subjects disclosed 1,267 execution sequences by executing 339 programs. Among them, the commands “rm,” “sed,” and “cat” were executed most frequently, generating 171 different sequences. By consolidating 530 million events into 240,000 access links, the disclosed technique achieved a reduction rate of 2,300 times.

During this simulation, PYTHON® scripts were executed 105 times to process documents, such as “.xlsx” files, while a subject “top” remained active to monitor the memory usage. The execution of PYTHON® scripts generated 57 million “read” events, which were consolidated into 3,500 access links. Meanwhile, the subject “top” generated 222 million “open” and 223 million “read” operations as it continuously monitored system resource usage for active subjects. These operations were merged into 13,000 access links. By excluding operations from these programs, the disclosed technique achieved a reduction of 74 times in the inventors' lab environments. In contrast, applying PCAR and S-DPR to these logs resulted in log size reductions by 8 and 14 times, respectively.

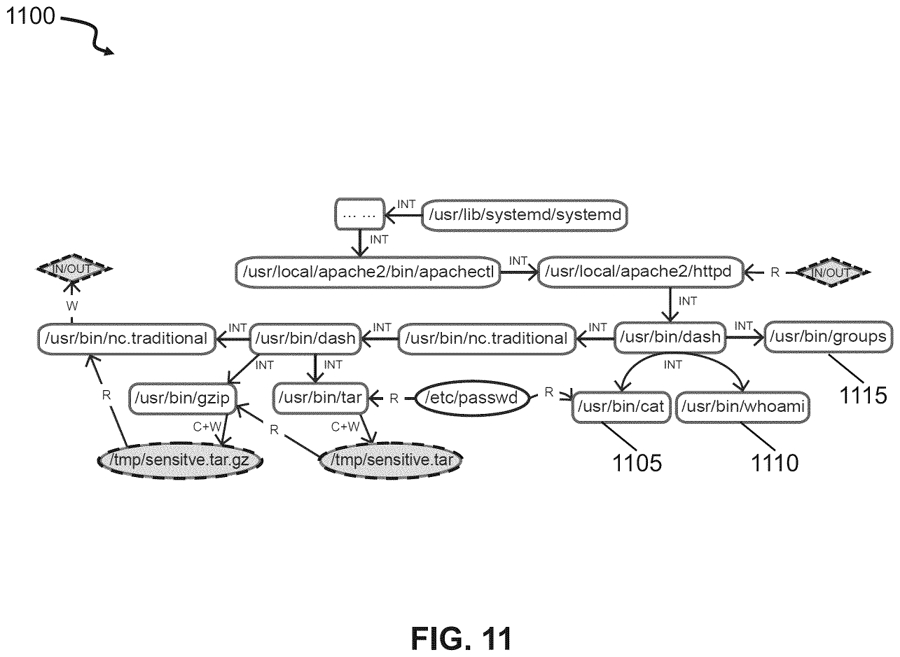

FIG. 11 is a schematic diagram of an experimental result for an access network.

In FIG. 11, an access network 1100 from the inventors' lab environments is shown that describes a simulation of a “ShellShock” attack targeting an APACHE® HTTP Server (APACHE2®) webserver. The attacker first sends malicious HyperText Transfer Protocol (HTTP) requests to open reverse shells with root privilege. The attack then discovers sensitive data on the webserver using commands such as “/usr/bin/cat” 1105, “/usr/bin/whoami” 1110, and “/usr/bin/groups” 1115. Once the sensitive files were found, the attack archives (tar) and compresses (gzip) the sensitive files and transfers (cp) them to the “/tmp” directory. Finally, the attacker downloads the files using “nc.traditional” and erases them.

Impacts on Reduction Performance: The inventors' analysis across LINUX®-based datasets indicated that the reduction performance of the access network is independent of the datasets used. However, the inventors noticed that the efficiency of the access network may vary across different machine workloads.

To gain a deeper view into the reduction performance, Table 5 below reports on the log reduction achieved for the top 3 applications in datasets from Cadets and Traces hosts, based on the number of events generated. The inventors observed that the efficiency of the access network decreases when programs access a wide range of objects during execution. For example, the access network reduced log size related to program “/usr/bin/du” in E3-Trace by only 7 times, as subjects “du” accessed 540,000 files. In contrast, the access network achieved outstanding reduction performance for programs with consistent activities, including a reduction of 107 times for “Xvnc4”, 71,000 times for “Isof”, and 182,000 times for “dlogd”. As a result, the access network according to example embodiments of the disclosed technique delivers remarkable overall log reduction.

TABLE 5

| Dataset | Application | % Events | % Links | Reduc |
|---|---|---|---|---|
| E3-Cadets | lsof | 30% | <<0.1% | 71,000x |
| | postfix | 12% | 6.3% | 53x |
| | python2.7 | 9% | 0.4% | 660x |
| E3-Trace | firefox | 33% | 41% | 22x |
| | thunderbird | 20% | 0.5% | 1,188x |
| | /usr/bin/du | 12% | 48% | 7x |
| E5-Cadets | dlogd | 18% | <<0.1% | 182,000x |
| | /usr/bin/cc | 18% | 12% | 57x |
| | /bin/sh | 15% | 16% | 25x |
| E5-Trace | Xvnc4 | 64% | <<0.1% | 107x |
| | pulseaudio | 14% | 1.4% | 2,233x |
| | landscape-sysinfo | 5% | 2.6% | 427x |

### Discussions

The experiments and simulations using the disclosed technique were primarily designed for LINUX® systems, which account for 96.3% of the top one million web servers. There may be limitations in WINDOWS® systems, which rely on thread creation with shared memory for execution and generate significantly fewer execution sequences as compared to LINUX® systems.

Applying Nano to WINDOWS®: Unlike LINUX® that uses “fork”/“exec” models to create processes with memory isolation for executing programs, WINDOWS® systems favor thread creation with shared memory. When a user launches a complex application in WINDOWS®, the system invokes a “CreateProcess( )” application programming interface (API) to create a process and load the executable image. However, the process itself does not directly execute code. It rather serves as a container for threads, which are the fundamental units of execution in WINDOWS®.

Each thread executes specified functions while sharing the memory space with other threads in the same process. This design facilitates inter-thread communication and results in fewer program invocation relationships as compared to LINUX® systems. For a WINDOWS® host in DARPA OpTC, 15,000 processes created 490,000 threads, which collectively executed 142 programs and generated 215 distinct execution sequences. In experiments, the disclosed technique consolidated 100 million events into 7 million access links (e.g., a reduction by 19 times). However, because threads within a process operate in shared memory, each read/write operation performed by one thread may be dependent on operations from other threads. Consequently, merging thread activities may obscure meaningful forensic information.

Note that processes in LINUX® systems can also clone threads with shared memory, particularly for long-running applications, such as graphical user interface (GUI) programs (e.g., THUNDERBIRD®) and web servers (e.g., FIREFOX®). However, unlike WINDOWS® systems that explicitly utilize threads, LINUX® systems primarily use the “fork”/“exec” model to create separate processes for execution. To optimize log reduction while conservatively preserving forensics, example embodiments can be leveraged to safely consolidate logs generated by the recurring execution of the same programs, while one can preserve logs from processes that extensively use multi-threading. For instance, in E3-Trace, the disclosed technique reduced log size by 64% by preserving logs from FIREFOX® while merging logs from other processes. This reduction again outperformed existing reduction techniques, such as S-DPR and PCAR, which reduced log size by 58% and 26% in E3-Trace, respectively.

Integrating the Disclosed Technique with Anomaly Detection: Prior research efforts observed that aggressive log reduction may degrade anomaly detection performance. The authors of the prior research analyzed the impact of reduced logs using three exemplar anomaly detection systems, including DeepLog, StreamSpot, and ProvDetector. The results indicated a significant decline in the model's ability to detect attacks and mitigate false alarms when an aggressive reduction technique is applied. For instance, with S-DPR enabled, ProvDetector flagged 45% of the paths in E3-Theia as suspicious.

Rather than merely integrating anomaly detection into the disclosed technique, example embodiments may be used as a long-term log retention mechanism. For example, a configurable batch size (e.g., 250,000) of the most recent logs can be retained and transformed into provenance graphs for anomaly detection, while the disclosed technique can be applied to consolidate outdated logs and preserve essential forensics. Alarms raised by anomaly detection can be accumulated into the access network, enabling security analysts to investigate attacks by correlating alarms using the disclosed technique. For instance, “FLASH” and “KAIROS” raise alarms on vertices and edges using provenance graph representation learning, respectively. These alarms can then be consolidated into access links to facilitate the reconstruction of attack scenarios across batches.

Impact of Mimicry Attacks: A prior study introduced mimicry attacks designed to evade anomaly detection systems operating at the graph-level granularity, such as Unicorn and StreamSpot. These attacks alter the distributional graph encoding by modifying the node neighborhoods in the attack graph to resemble those in benign graphs. Mimicry attacks do not change the connectivity between malicious entities. For instance, “FLASH,” an anomaly detection system operating at the node-level granularity, is robust against these attacks. Similarly, the disclosed technique is resilient to mimicry attacks, as the access network preserves the essential forensic details within the provenance graph.

For “Living-off-the-Land” (LoTL) attacks that use legitimate utilities to conduct malicious activities, the profile hierarchy in the disclosed technique explicitly captures their invocation relationships. For instance, FIG. 11 illustrates the execution sequences of profiles denoted by legitimate commands, such as “bash,” “cat,” and “whoami,” which were invoked by APACHE2® when it was exploited in the simulation. As these commands were not commonly executed by APACHE2®, their execution sequences under the profile “apache2” enable analysts to quickly identify abnormal behaviors and respond accordingly.

### Related Work

Log Reduction: Existing research has developed techniques that reduce log size while preserving forensic evidence. “LogGC” first removes temporary file I/O and other “dead end” activities leveraging Blocks Extensible Exchange Protocol (BEEP), which is a binary-based execution partition technique. “ProTracer” again uses BEEP to develop a new logging system that aims at reducing log volume. “KCAL” introduced a kernel-level cache designed to reduce the runtime overhead of transferring logs from kernel to user space, and also to reduce storage overhead by removing redundant events. However, these methods need extensive software/kernel instrumentation.

In the meantime, other studies examined the activities of subjects based on enforced security policies, and discard events that fall outside policies. “DEPIMPACT” identified the critical components of a graph given a Point-of-Interest (POI) event, which then reduces memory overhead. “FAUST” combines existing reduction techniques for efficient log retention. However, these techniques remove overlapping sets of activities from system logs, limiting the cumulative benefits of applying them in tandem.

Dependency Explosion Problem: The “Dependency Explosion Problem” refers to the rapid growth of dependencies in PIDSes due to coarse-grained provenance. The access network may face this challenge, as it merges activities from different subjects into access links for a single profile, which may generate a substantial number of dependencies. One may mitigate this issue by applying various techniques, such as a tag-based information flow propagation system that raises alarms when specific confidentiality/integrity conditions are met, or tag propagation to generate a scenario graph that encompasses the majority of attack activities. Other fine-grained tracking strategies may introduce significant performance overhead due to the kernel/software instrumentation.

Heuristic-based Detection: Enterprises rely on intrusion detection systems to analyze audit streams and raise alerts, enabling analysts to respond to potential threats. Existing detection can be broadly classified into heuristic-based and anomaly-based detection.

Heuristic detection uses existing knowledge of attacks to define event-matching rules, which are then matched against the audit stream to raise alerts. HOLMES is the first approach to apply rules on data provenance; it correlates alerts from the same event stream and translates them into high-level scenario graphs to describe attack behaviors. However, HOLMES assumes 100% log retention, making it practically prohibitive due to the limited storage capacity of enterprises. In contrast, RapSheet builds a skeleton graph that only retains the connectivity between alerts raised by Tactics, Techniques, and Procedures (TTP) rulesets. While RapSheet integrates data provenance into commercial Endpoint Detection and Response (EDR) tools, it still incurs significant storage overhead due to the large volume of alerts generated by EDR systems.

Anomaly-based Detection: In contrast to heuristic detection, anomaly detection relies on various machine learning models trained on benign behaviors to identify deviations that may indicate malicious activities.

For detection models operating at the graph-level granularity, they decompose the provenance graph into various embeddings and detect abnormal graphs whenever these deviate from established models. Similar approaches include ProGrapher and Unicorn. In contrast, FLASH and ThreaTrace use a Graph Neural Network (GNN) to execute node-level anomaly detection. They train GNNs to learn the semantic/structural information of nodes in benign datasets and identify anomalies based on deviations.

Example embodiments of the present disclosure may provide a real-time log reduction approach for LINUX®-based systems, which consolidates consistent activities of duplicate subjects into access links associated with program nodes when their executions follow specific execution sequences. The inventors' experimental evaluation demonstrated that the disclosed technique reduces log size by up to 219 times at runtime, enabling the storage of months or even years worth of forensic data in the same space that existing PIDSes would consume in a few days. By reconstructing data dependencies between access links, the inventors demonstrates that the disclosed technique achieves detection accuracy comparable to existing provenance-based detection systems while significantly reducing server-side memory overhead.

Example embodiments may provide real-time reduction/consolidation of duplicate logs. Detection of malicious elements may still be performed offline. Conventional techniques perform the reduction offline after a process is completed. For example, 100 GB may be processed to be reduced, which may take a significant amount of time, e.g., 1-2 days, plus pre-processing, when not performed in real-time. Example embodiments do not have to wait overnight or longer for the reduction phase before detection processing can occur, as in conventional techniques. Example embodiments may use existing detection techniques after the reduction/consolidation is performed in accordance with the disclosed technique. Thus, detection accuracy is comparable to conventional techniques, but the entire process from initiation of runtime to detection is reduced by using the disclosed technique in accordance with example embodiments of the present disclosure.

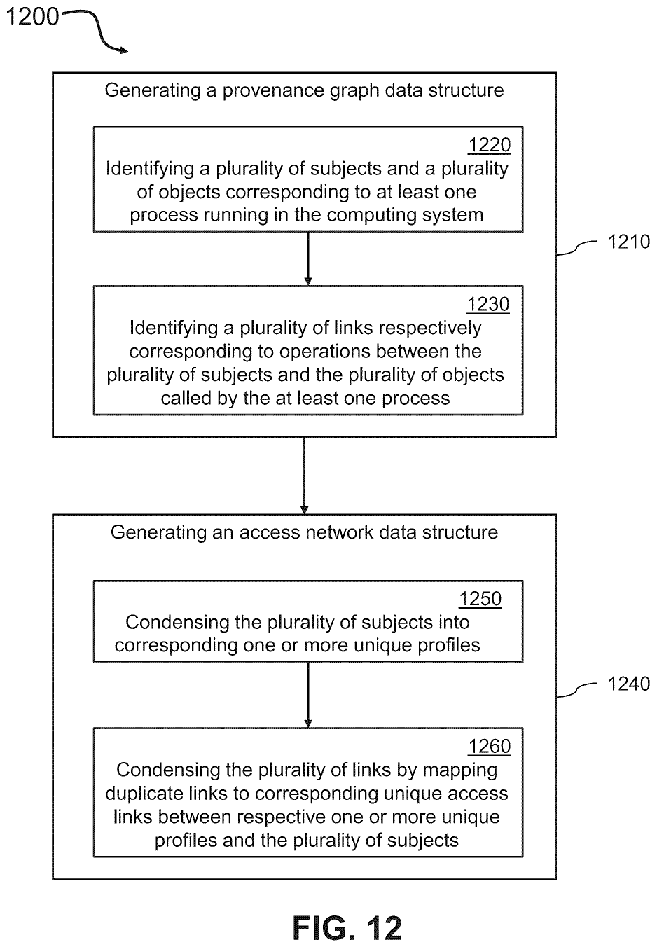

FIG. 12 is a flowchart for an example method.

In FIG. 12, an example method 1200 for real-time program-specific log consolidation for intrusion detection in a computing system, which may be performed in real-time during operation of the computing system, may include, at 1210, generating a provenance graph data structure including: at 1220, identifying a plurality of subjects and a plurality of objects corresponding to at least one process running in the computing system, and, at 1230, identifying a plurality of links respectively corresponding to operations between the plurality of subjects and the plurality of objects called by the at least one process. The example method 1200 may further include, at 1240, generating an access network data structure including: at 1250, condensing the plurality of subjects into corresponding one or more unique profiles, and, at 1260, condensing the plurality of links by mapping duplicate links to corresponding unique access links between respective one or more unique profiles and the plurality of subjects.

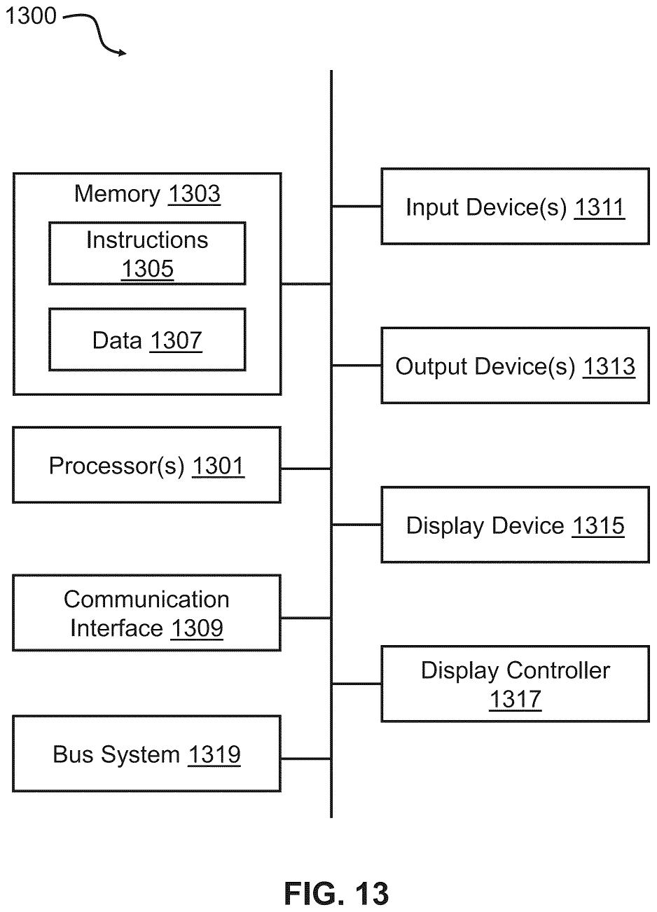

FIG. 13 illustrates certain components that may be included within a computer system according to an example embodiment of the present disclosure.

FIG. 13 illustrates certain components that may be included within a computer system 1300, which may be used to control features according to embodiments of the present disclosure, such as the features discussed with reference to FIGS. 1-12. One or more computer systems 1300 may be used to implement the various devices, components, and systems described herein.

The computer system 1300 includes one or more processors 1301. The processor(s) 1301 may be a single processor or may include multiple processors and/or sub-processors. The processor(s) 1301 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor(s) 1301 may be referred to as a central processing unit (CPU). Although a single processor(s) 1301 is shown in the computer system 1300 of FIG. 13, in an alternative configuration, a combination of processors (e.g., an ARM and DSP) could be used. In one or more embodiments, the computer system 1300 further includes one or more graphics processing units (GPUs), which can provide processing services related to both entity classification and graph generation.

The computer system 1300 also includes memory 1303 in electronic communication with the processor(s) 1301. The memory 1303 may be any electronic component capable of storing electronic information. For example, the memory 1303 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory device or multiple memory devices.

Instructions 1305 and data 1307 may be stored in the memory 1303. The instructions 1305 may be executable by the processor(s) 1301 to implement some or all of the functionality disclosed herein. Executing the instructions 1305 may involve the use of the data 1307 that is stored in the memory 1303. Any of the various examples of modules and components described herein may be implemented, partially or wholly, as instructions 1305 stored in memory 1303 and executed by the processor(s) 1301. Any of the various examples of data described herein may be among the data 1307 that is stored in memory 1303 and used during execution of the instructions 1305 by the processor(s) 1301.

A computer system 1300 may also include one or more communication interfaces 1309 for communicating with other electronic devices. The communication interface(s) 1309 may be based on wired communication technology, wireless communication technology, or both. Some examples of communication interfaces 1309 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1300 may also include one or more input devices 1311 and one or more output devices 1313. Some examples of input devices 1311 include a keyboard, mouse, microphone, remote control device, button, joystick, trackball, touchpad, and lightpen. Some examples of output devices 1313 include a speaker and a printer. One specific type of output device that is typically included in a computer system 1300 is a display device 1315. Display devices 1315 used with embodiments disclosed herein may utilize any suitable image projection technology, such as liquid crystal display (LCD), light-emitting diode (LED), gas plasma, electroluminescence, or the like, and may be provided in any desired number. At least one display controller 1317 may also be provided, for converting data 1307 stored in the memory 1303 into text, graphics, and/or moving images (as appropriate) shown on the display device 1315.

The various components of the computer system 1300 may be coupled together by one or more buses, which may include a power bus, a control signal bus, a status signal bus, a data bus, etc. For the sake of clarity, the various buses are illustrated in FIG. 13 as a bus system 1319.

The following are sections in accordance with at least one embodiment of the present disclosure:

Clause 1: A method for real-time program-specific log consolidation for intrusion detection in a computing system, including, in real-time during operation of the computing system: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

Clause 2: The method of clause 1, wherein repeated operations are aggregated into the unique access links based on respective execution sequences of the operations.

Clause 3: The method of clause 1, further including consolidating duplicate logs from respective ones among the plurality of subjects that originate from a same execution sequence.

Clause 4: The method of clause 1, further including identifying a malicious object among the plurality of objects based on a malicious object triggering an alert.

Clause 5: The method of clause 4, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

Clause 6: The method of clause 4, further including determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

Clause 7: One or more non-transitory computer-readable media storing instructions that, when executed by at least one processor of a computing system, cause the computing system to execute instructions for real-time program-specific log consolidation for intrusion detection in the computing system in real-time during operation of the computing system, the instructions including: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

Clause 8: The one or more non-transitory computer-readable media of clause 7, wherein repeated operations are aggregated into the unique access links based on respective execution sequences of the operations.

Clause 9: The one or more non-transitory computer-readable media of clause 7, wherein the instructions further include consolidating duplicate logs from respective ones among the plurality of subjects that originate from a same execution sequence.

Clause 10: The one or more non-transitory computer-readable media of clause 7, wherein the instructions further include identifying a malicious object among the plurality of objects based on a malicious object triggering an alert.

Clause 11: The one or more non-transitory computer-readable media of clause 10, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

Clause 12: The one or more non-transitory computer-readable media of clause 10, wherein the instructions further include determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

Clause 13: A system for real-time program-specific log consolidation for intrusion detection, including: one or more processors, and at least one memory including at least one non-transitory computer-readable medium storing instructions for real-time program-specific log consolidation for intrusion detection in a computing system that, when executed by at least one of the one or more processors, cause the system to perform actions corresponding to the instructions in real-time during operation of the computing system, the instructions including: generating a provenance graph data structure including: identifying a plurality of subjects and a plurality of objects corresponding to at least one process running in the computing system, and identifying a plurality of links respectively corresponding to operations between the plurality of subjects and the plurality of objects called by the at least one process, and generating an access network data structure including: condensing the plurality of subjects into corresponding one or more unique profiles, and condensing the plurality of links by mapping duplicate links to corresponding unique access links between respective one or more unique profiles and the plurality of subjects.

Clause 14: The system of clause 13, wherein repeated operations are aggregated into the unique access links based on respective execution sequences of the operations.

Clause 15: The system of clause 13, wherein the instructions further include consolidating duplicate logs from respective ones among the plurality of subjects that originate from a same execution sequence.

Clause 16: The system of clause 13, wherein the instructions further include identifying a malicious object among the plurality of objects based on a malicious object triggering an alert.

Clause 17: The system of clause 16, wherein: the alert is assigned a weight value corresponding to a confidence level of the alert, the weight value is aggregated for each time the malicious object is called by a profile in the access network data structure, and the alert is triggered when the aggregated weight value exceeds a stress threshold value.

Clause 18: The system of clause 16, wherein the instructions further include determining an overall threat score for the access network data structure, including: assigning each alert to a respective one of a plurality of attack stages, assigning a threat severity value to each of the plurality of attack stages, and calculating the overall threat score for the access network data structure according to:

$$TS = {\prod }_{i = 1}^{7} {( {S}_{i} )}^{{ω}_{i}} ,$$

where: Sᵢ denotes a highest threat severity value in stage i among the plurality of attack stages, and ωᵢ is a weight assigned for stage i.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either wired, wireless, or a combination of wired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about,” “˜”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words “means for” appear together with an associated function. Each addition, deletion, and modification to the embodiments that falls within the meaning and scope of the claims is to be embraced by the claims. Any trademarks mentioned herein are the property of their respective owners. Example embodiments are not limited to any particularly-mentioned products, trademarks, or properties.

The terms “approximately,” “about,” “˜”, and “substantially” as used herein represent an amount close to the stated amount that still performs a desired function or achieves a desired result. For example, the terms “approximately,” “about,” “˜”, and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for real-time program-specific log consolidation for intrusion detection in a computing system, comprising, in real-time during operation of the computing system:
generating a provenance graph data structure comprising:
identifying a plurality of subjects and a plurality of objects corresponding to at least one process running in the computing system; and
identifying a plurality of links respectively corresponding to operations between the plurality of subjects and the plurality of objects called by the at least one process; and
generating an access network data structure comprising:
condensing the plurality of subjects into corresponding one or more unique profiles; and
condensing the plurality of links by mapping duplicate links to corresponding unique access links between respective one or more unique profiles and the plurality of subjects.

2. The method of claim 1, wherein repeated operations are aggregated into the unique access links based on respective execution sequences of the operations.

3. The method of claim 1, further comprising consolidating duplicate logs from respective ones among the plurality of subjects that originate from a same execution sequence.

4. The method of claim 1, further comprising identifying a malicious object among the plurality of objects based on a malicious object triggering an alert.

5. The method of claim 4, wherein:
the alert is assigned a weight value corresponding to a confidence level of the alert;
the weight value is aggregated for each time the malicious object is called by a profile in the access network data structure; and
the alert is triggered when the aggregated weight value exceeds a stress threshold value.

6. The method of claim 4, further comprising determining an overall threat score for the access network data structure, comprising:
assigning each alert to a respective one of a plurality of attack stages;
assigning a threat severity value to each of the plurality of attack stages; and
calculating the overall threat score for the access network data structure according to:
$$TS = {\prod }_{i = 1}^{7} {( {S}_{i} )}^{{ω}_{i}} ,$$
where:
Sᵢ denotes a highest threat severity value in stage i among the plurality of attack stages, and
ωᵢ is a weight assigned for stage i.

7. One or more non-transitory computer-readable media storing instructions that, when executed by at least one processor of a computing system, cause the computing system to execute instructions for real-time program-specific log consolidation for intrusion detection in the computing system in real-time during operation of the computing system, the instructions comprising:
generating a provenance graph data structure comprising:
identifying a plurality of subjects and a plurality of objects corresponding to at least one process running in the computing system; and
identifying a plurality of links respectively corresponding to operations between the plurality of subjects and the plurality of objects called by the at least one process; and
generating an access network data structure comprising:
condensing the plurality of subjects into corresponding one or more unique profiles; and
condensing the plurality of links by mapping duplicate links to corresponding unique access links between respective one or more unique profiles and the plurality of subjects.

8. The one or more non-transitory computer-readable media of claim 7, wherein repeated operations are aggregated into the unique access links based on respective execution sequences of the operations.

9. The one or more non-transitory computer-readable media of claim 7, wherein the instructions further include consolidating duplicate logs from respective ones among the plurality of subjects that originate from a same execution sequence.

10. The one or more non-transitory computer-readable media of claim 7, wherein the instructions further include identifying a malicious object among the plurality of objects based on a malicious object triggering an alert.

11. The one or more non-transitory computer-readable media of claim 10, wherein:
the alert is assigned a weight value corresponding to a confidence level of the alert;
the weight value is aggregated for each time the malicious object is called by a profile in the access network data structure; and
the alert is triggered when the aggregated weight value exceeds a stress threshold value.

12. The one or more non-transitory computer-readable media of claim 10, wherein the instructions further include determining an overall threat score for the access network data structure, comprising:
assigning each alert to a respective one of a plurality of attack stages;
assigning a threat severity value to each of the plurality of attack stages; and
calculating the overall threat score for the access network data structure according to:
$$TS = {\prod }_{i = 1}^{7} {( {S}_{i} )}^{{ω}_{i}} ,$$
where:
Sᵢ denotes a highest threat severity value in stage i among the plurality of attack stages, and
ωᵢ is a weight assigned for stage i.

13. A system for real-time program-specific log consolidation for intrusion detection, comprising:
one or more processors; and
at least one memory comprising at least one non-transitory computer-readable medium storing instructions for real-time program-specific log consolidation for intrusion detection in a computing system that, when executed by at least one of the one or more processors, cause the system to perform actions corresponding to the instructions in real-time during operation of the computing system, the instructions comprising:
generating a provenance graph data structure comprising:
identifying a plurality of subjects and a plurality of objects corresponding to at least one process running in the computing system; and
identifying a plurality of links respectively corresponding to operations between the plurality of subjects and the plurality of objects called by the at least one process; and
generating an access network data structure comprising:
condensing the plurality of subjects into corresponding one or more unique profiles; and
condensing the plurality of links by mapping duplicate links to corresponding unique access links between respective one or more unique profiles and the plurality of subjects.

14. The system of claim 13, wherein repeated operations are aggregated into the unique access links based on respective execution sequences of the operations.

15. The system of claim 13, wherein the instructions further include consolidating duplicate logs from respective ones among the plurality of subjects that originate from a same execution sequence.

16. The system of claim 13, wherein the instructions further include identifying a malicious object among the plurality of objects based on a malicious object triggering an alert.

17. The system of claim 16, wherein:
the alert is assigned a weight value corresponding to a confidence level of the alert;
the weight value is aggregated for each time the malicious object is called by a profile in the access network data structure; and
the alert is triggered when the aggregated weight value exceeds a stress threshold value.

18. The system of claim 16, wherein the instructions further include determining an overall threat score for the access network data structure, comprising:
assigning each alert to a respective one of a plurality of attack stages;
assigning a threat severity value to each of the plurality of attack stages; and
calculating the overall threat score for the access network data structure according to:
$$TS = {\prod }_{i = 1}^{7} {( {S}_{i} )}^{{ω}_{i}} ,$$
where:
Sᵢ denotes a highest threat severity value in stage i among the plurality of attack stages, and
ωᵢ is a weight assigned for stage i.
